(19) United States
(12) Patent Application Publication
(10) Pub. No.: US 2025/0337461 A1
(43) Pub. Date: Oct. 30, 2025

(54) UE CAPABILITY AND SRS CONFIGURATION FOR CLOSED-LOOP ANTENNA SELECTION

(71) Applicant: QUALCOMM Incorporated, San Diego, CA (US)

(72) Inventors: Hyojin LEE, San Diego, CA (US); Yu ZHANG, San Diego, CA (US); Jing JIANG, San Diego, CA (US); Jing SUN, San Diego, CA (US); Enoch Shiao-Kuang LU, San Diego, CA (US); Jianming ZHU, Acton, MA (US); Hari SANKAR, San Diego, CA (US)

(21) Appl. No.: 18/649,364

(22) Filed: Apr. 29, 2024

(51) Int. Cl. H04B 7/06; H04L 5/00

(52) U.S. Cl. CPC H04B 7/0602; H04L 5/0048

(57) ABSTRACT

UE capability and SRS configuration for closed-loop antenna selection is described. An apparatus may be configured to transmit, for a network node, antenna selection capability information based on a first number of Tx chains at the UE and a second number of antenna ports at the UE. The apparatus may be configured to receive, from the network node and based on the antenna selection capability information, a SRS configuration indicative of a set of SRS resources for the first number of Tx chains at the UE and the second number of antenna ports at the UE associated with the first number of Tx chains for antenna selection.

### TECHNICAL FIELD

The present disclosure relates generally to communication systems, and more particularly, to wireless systems utilizing antenna selection.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or the method may be performed by or at, a user equipment (UE). The apparatus is configured to transmit antenna selection capability information based on a first number of transmission (Tx) chains at the UE and a second number of antenna ports at the UE. The apparatus is also configured to receive, from a network node and based on the antenna selection capability information, a sounding reference signal (SRS) configuration indicative of a set of SRS resources for the first number of Tx chains at the UE and the second number of antenna ports at the UE associated with the first number of Tx chains for antenna selection.

In the aspect, the method includes transmitting antenna selection capability information based on a first number of Tx chains at the UE and a second number of antenna ports at the UE. The method also includes receiving, from a network node and based on the antenna selection capability information, a SRS configuration indicative of a set of SRS resources for the first number of Tx chains at the UE and the second number of antenna ports at the UE associated with the first number of Tx chains for antenna selection.

In another aspect of the disclosure, a method, a computer-readable medium, and an apparatus are provided. The apparatus is configured to receive, from a UE, antenna selection capability information associated with a first number of Tx chains at the UE and a second number of antenna ports at the UE. The apparatus is also configured to configure the UE, based on the antenna selection capability information, with a SRS configuration indicative of a set of SRS resources for the first number of Tx chains at the UE and the second number of antenna ports at the UE associated with the first number of Tx chains for antenna selection.

In the aspect, the method includes receiving, from a UE, antenna selection capability information associated with a first number of Tx chains at the UE and a second number of antenna ports at the UE. The method also includes configuring the UE, based on the antenna selection capability information, with a SRS configuration indicative of a set of SRS resources for the first number of Tx chains at the UE and the second number of antenna ports at the UE associated with the first number of Tx chains for antenna selection.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of antenna switching/selection for transmission (Tx) chains associated with antenna ports at a UE.

FIG. 5 is a call flow diagram for wireless communications, in accordance with various aspects of the present disclosure.

FIG. 6 is a diagram illustrating an example of UE capability reporting for AS architectures, in accordance with various aspects of the present disclosure.

FIG. 7 is a diagram illustrating an example of UE capability reporting for AS architectures, in accordance with various aspects of the present disclosure.

FIG. 8 is a diagram illustrating an example of SRS configuration for antenna selection (AS), in accordance with various aspects of the present disclosure.

FIG. 9 is a diagram illustrating an example of SRS configuration for AS, in accordance with various aspects of the present disclosure.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

Wireless communication networks may be designed to support communications between network entities/network nodes (e.g., base stations, gNBs, components in a core network, etc.) and UEs. For instance, a UE in a wireless communication network may communicate in various configurations and using various communication schema with a network node utilizing Tx chains and associated antennas. In one example, such as for UL, a UE may have a smaller number of Tx chains (e.g., a maximum number of baseband layers) than the number of antennas, and such extra antennas may be already available for reception (Rx) purposes (e.g., there may typically be more Rx chains that are employed than Tx chains). If a UE is capable of switching connections from chains to antennas, it may be beneficial to select the best set of antennas via antenna selection (AS) to be connected to the chains, depending on per-antenna Tx power budget, the overall propagation channel from UE baseband to gNB baseband, etc., where a power amplifier for Tx may could be per-chain or per-antenna. For codebook (CB)-based uplink multiple-input and multiple-output (MIMO) scenarios, a UE may be configured with up to two SRS resources per set based on current solutions. Each resource in a given set may have the same number of SRS ports. In UL grants, an SRS resource indicator (SRI) selects one of the two resources, and a transmit precoding matrix indicator (TPMI) provides precoding information on the selected p-port SRS resources. If CB-based uplink MIMO for p chains and q antennas is reused for AS, two SRS resources (e.g., each with p-ports) may be configured, each resource may correspond to different connection cases which may be transparent to the network (e.g., a base station, gNB, etc.), and the network may select one from the two connections (e.g., each corresponds to each SRS resource) and indicate it using the SRI. For non-codebook (NCB)-based uplink MIMO, a UE may be configured with up to 4 (or 8) SRS resources per set, and each resource may have a single port. In UL grants, the SRI may select ‘k’ (e.g., where k<min(Lₘₐₓ, N_{SRS})) of the configured SRS resources, and TPMI may not transmitted. Again, if NCB-based uplink MIMO for p chains and q antennas is reused for antenna selection, ‘q’ SRS resources (e.g., each corresponding to each antenna) may be configured, Lₘₐₓ may be set as ‘p’, and the network may choose up to ‘p’ of the ‘q’ resources. In 5G NR, UL AS may be determined by a UE in an open-loop manner (e.g., as transparent to the network). In some solutions, the best set of antennas may be determined based on DL measurements and per-antenna power budget, such as when some level of UL/DL reciprocity may be assumed/determined.

However, the CB-based UL MIMO approach noted above cannot support sufficient flexibility to support different connection cases from chains to antennas, and simple extensions increasing the number of resources leads to significant increases to SRS resource overhead. Similarly, the NCB-based UL MIMO approach noted above has drawbacks, as such an approach may be applicable to non-coherent and fully connected AS architectures but not to other AS architectures. Additionally, there are drawbacks for such open-loop UL AS solutions, as described above, due to mismatches between UL and DL on insertion loss, antenna correlation for frequency division duplexed (FDD)/time division duplexed (TDD), and propagation channel-related parameters, e.g., especially in FDD. When a UE has a larger number of chains and antennas (e.g., as seen in some trends for UE improvement), the impact of such mismatches may be further increased.

Various aspects relate generally to wireless systems utilizing antenna selection. Some aspects more specifically relate to UE capability and SRS configuration for closed-loop antenna selection. In some examples, a UE may be configured to provide, e.g., to a base station, gNB, etc., capability reporting associated with antenna selection architecture(s) of the UE. In aspects, this may be referenced as “pCqA,” where there are ‘p’ Tx chains and ‘q’ antenna ports, and where p>q. In some examples, pCqA may include a number ‘p’ of Tx chains, where (p): (1), 2, 3, 4, and may include a number ‘q’ of antenna ports, where (q): (2), 3, 4, 6, 8. In some examples, a UE may be configured to provide connection capability(ies) between Tx chains and antenna ports and/or indications for consideration of carrier aggregation. In some examples, SRS configuration for AS may be utilized, e.g., based on the capability reporting. For instance, SRS-based uplink beam management procedures may be reused, antenna switching SRS configuration may be reused, explicit configurations with antenna indices for each SRS resource may be used, implicit rule to derive AS SRS configurations may be used, and/or time-domain implicit antenna switching based on AS may be used. In some examples, a UE may perform AS operations based network-generated parameters, e.g., calculated based on AS SRS measurements, and a network node may perform AS operations based on UE assistance information and AS SRS measurements.

Particular aspects of the subject matter described in this disclosure can be implemented to realize one or more of the following potential advantages. In some examples, by enabling a UE and the network to cooperatively choose the best set of antennas based on SRS, the described techniques can be used to provide closed-loop UL AS support. In some examples, by enabling a UE and the network to cooperatively choose the best set of antennas based on SRS, the described techniques can be used to enable closed-loop antenna selection in NR with CB- or NCB-based uplink MIMO.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

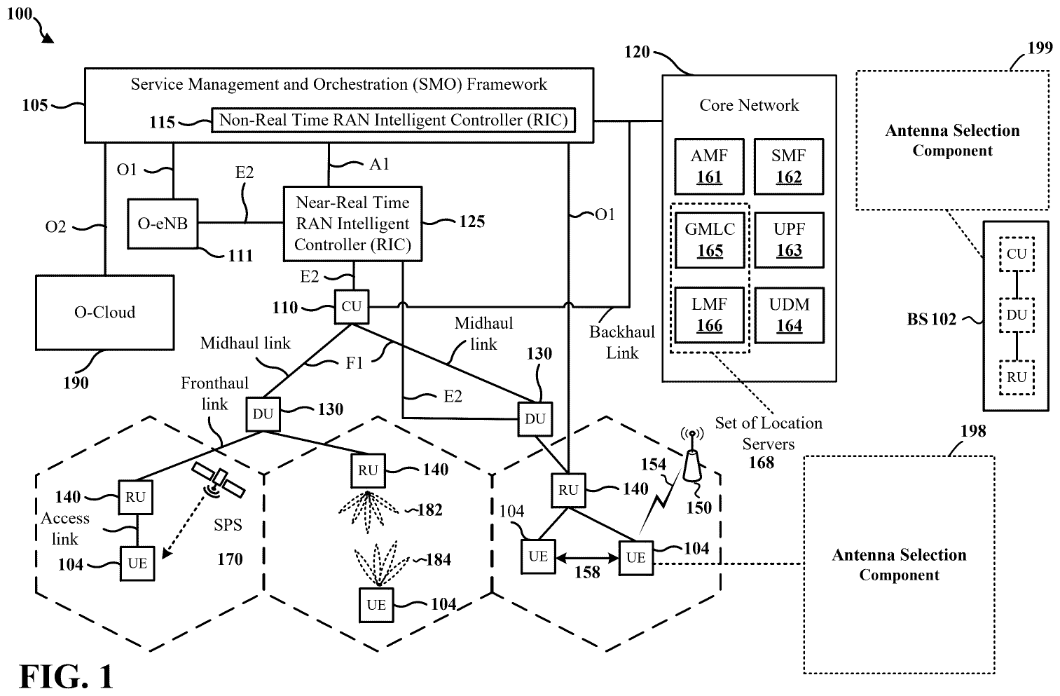

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an antenna selection component 198 (“component 198”) that may be configured to transmit antenna selection capability information based on a first number of Tx chains at the UE and a second number of antenna ports at the UE. The component 198 may also be configured to receive, from a network node and based on the antenna selection capability information, a SRS configuration indicative of a set of SRS resources for the first number of Tx chains at the UE and the second number of antenna ports at the UE associated with the first number of Tx chains for antenna selection. The component 198 may also be configured to provide, for the network node, an SRS transmission in accordance with the SRS configuration. The component 198 may also be configured to select a set of antennas associated with the second number of antenna ports and a corresponding Tx chain from the first number of Tx chains based on the SRS configuration for the antenna selection. The component 198 may also be configured to communicate, with the network node, in accordance with the set of antennas and the corresponding Tx chain. In certain aspects, the base station 102 may have an antenna selection component 199 (“component 199”) that may be configured to receive, from a UE, antenna selection capability information associated with a first number of Tx chains at the UE and a second number of antenna ports at the UE. The component 199 may also be configured to configure the UE, based on the antenna selection capability information, with a SRS configuration indicative of a set of SRS resources for the first number of Tx chains at the UE and the second number of antenna ports at the UE associated with the first number of Tx chains for antenna selection. The component 199 may also be configured to receive, from the UE, an SRS transmission in accordance with the SRS configuration. The component 199 may also be configured to provide, for the UE, antenna selection information indicative of a set of antennas and a corresponding Tx chain or an indication of the set of antennas based on the SRS transmission associated with the SRS configuration. The component 199 may also be configured to communicate, with the UE, in accordance with the set of antennas and the corresponding Tx chain. Accordingly, aspects herein enable a UE and the network to cooperatively choose the best set of antennas based on SRS, such as via UE capability reporting, SRS configuration for AS, and AS operations, and thus provide closed-loop UL AS support.

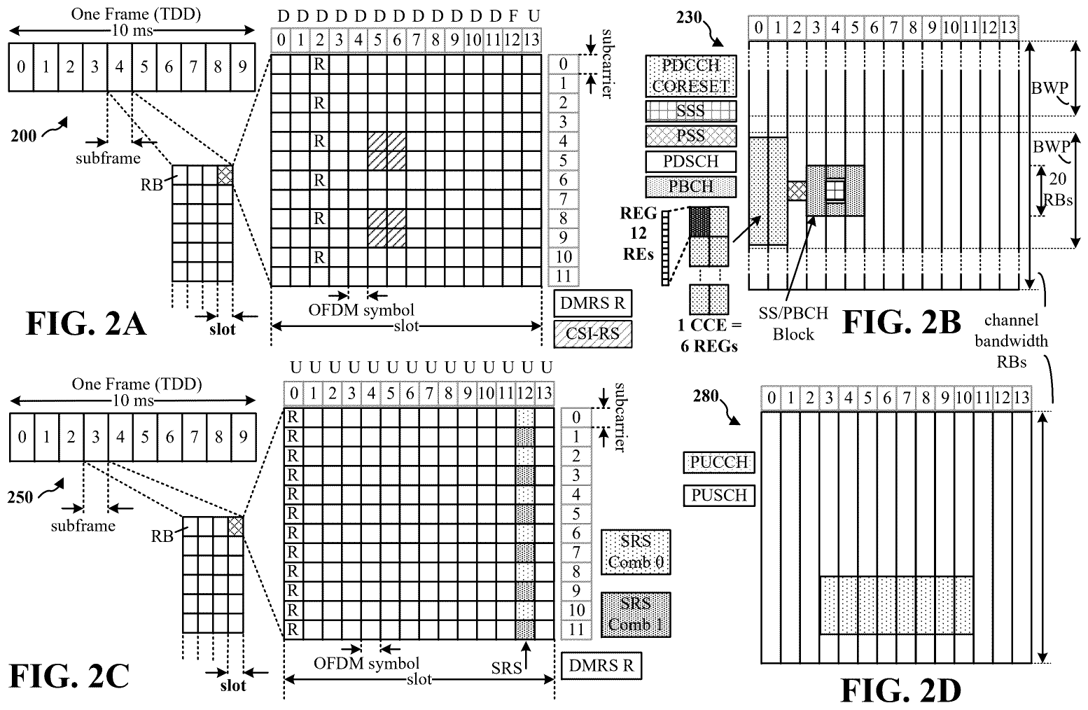

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

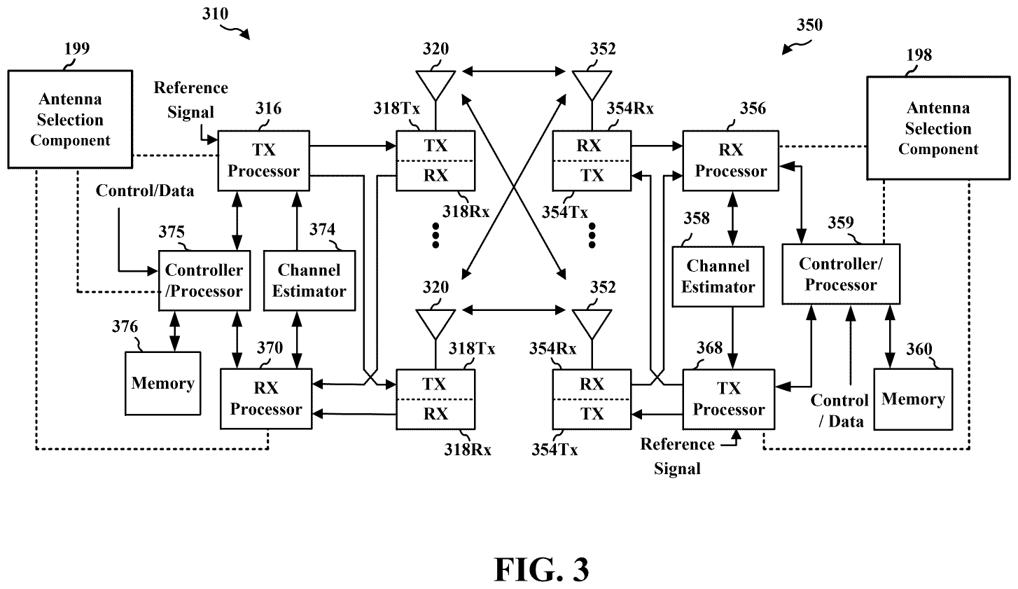

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE in a wireless communication network may communicate in various configurations and using various communication schema with a network node utilizing Tx chains and associated antennas. In one example, such as for UL, a UE may have a smaller number of Tx chains (e.g., a maximum number of baseband layers) than the number of antennas, and such extra antennas may be already available for reception (Rx) purposes (e.g., there may typically be more Rx chains that are employed than Tx chains). If a UE is capable of switching connections from chains to antennas, it may be beneficial to select the best set of antennas via AS to be connected to the chains, depending on per-antenna Tx power budget, the overall propagation channel from UE baseband to gNB baseband, etc., where a power amplifier for Tx may could be per-chain or per-antenna. For CB-based uplink MIMO scenarios, a UE may be configured with up to two SRS resources per set based on current solutions. Each resource in a given set may have the same number of SRS ports. In UL grants, an SRI selects one of the two resources, and a TPMI provides precoding information on the selected p-port SRS resources. If CB-based uplink MIMO for p chains and q antennas is reused for AS, two SRS resources (e.g., each with p-ports) may be configured, each resource may correspond to different connection cases which may be transparent to the network (e.g., a base station, gNB, etc.), and the network may select one from the two connections (e.g., each corresponds to each SRS resource) and indicate it using the SRI. For NCB-based uplink MIMO, a UE may be configured with up to 4 (or 8) SRS resources per set, and each resource may have a single port. In UL grants, the SRI may select ‘k’ (e.g., where k<min(Lₘₐₓ, N_{SRS})) of the configured SRS resources, and TPMI may not transmitted. Again, if NCB-based uplink MIMO for p chains and q antennas is reused for antenna selection, ‘q’ SRS resources (e.g., each corresponding to each antenna) may be configured, Lₘₐₓ may be set as ‘p’, and the network may choose up to ‘p’ of the ‘q’ resources. In 5G NR, UL AS may be determined by a UE in an open-loop manner (e.g., as transparent to the network). In some solutions, the best set of antennas may be determined based on DL measurements and per-antenna power budget, such as when some level of UL/DL reciprocity may be assumed/determined. However, the CB-based UL MIMO approach noted above cannot support sufficient flexibility to support different connection cases from chains to antennas, and simple extensions increasing the number of resources leads to significant increases to SRS resource overhead. Similarly, the NCB-based UL MIMO approach noted above has drawbacks, as such an approach may be applicable to non-coherent and fully connected AS architectures but not to other AS architectures. Additionally, there are drawbacks for such open-loop UL AS solutions, as described above, due to mismatches between UL and DL on insertion loss, antenna correlation for frequency division duplexed FDD/TDD, and propagation channel-related parameters, e.g., especially in FDD. When a UE has a larger number of chains and antennas (e.g., as seen in some trends for UE improvement), the impact of such mismatches may be further increased.

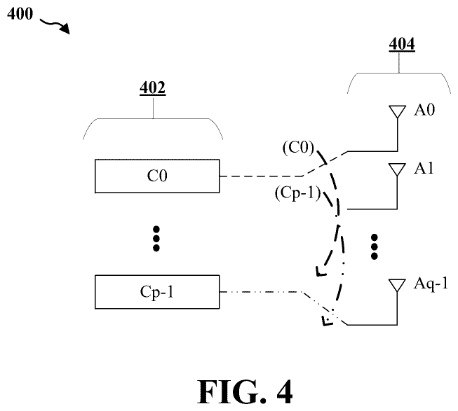

FIG. 4 is a diagram 400 illustrating an example of antenna switching for Tx chains associated with antenna ports at a UE. Diagram 400 illustrates a number ‘p’ of Tx chains 402 that includes a Tx chain C0 and Tx chain Cp−1, e.g., a Tx chain 0 to a Tx chain p−1. For instance, if p=2, e.g., there are two Tx chains, as illustrated by way of example: C0 and Cp−1 (where p−1=1). Each of the number of Tx chains 402 may connect to antennas of the number ‘q’ of antennas 404 (e.g., an antenna A0, an antenna A1, . . . , an antenna Aq−1) in various configurations. For instance, if q=3, e.g., there are three antennas in the number of antennas 404, as illustrated by way of example: A0, A1, Aq−1 (where q−1=2). As noted herein for UL contexts of a UE, the number of Tx chains 402 (e.g., a maximum number of baseband layers) may be smaller than the number of antennas 404, and such extra antennas may be already available for reception (Rx) purposes (e.g., there may typically be more Rx chains that are employed than Tx chains). If a UE is capable of switching connections from chains to antennas, it may be beneficial to select the best set of antennas via AS to be connected to the chains, depending on per-antenna Tx power budget, the overall propagation channel from UE baseband to gNB baseband, etc., where a power amplifier for Tx may could be per-chain or per-antenna.

Aspects herein propose enhancing UE capability reporting and SRS configuration for UL antenna selection (AS). In aspects, xTyR may be enhanced to additionally indicate all the possible connection types and provide SRS configuration to sound all Tx chain-to-antenna connections per port. Aspects provide xTyR-to-pCqA notation, with ‘p’ Tx chains (e.g., ports) and ‘q’ antennas/antenna ports (e.g., independent channel) terminology to differentiate open-loop vs closed-loop operation, but ultimately an enhancement to xTyR. The aspects herein for UE capability and SRS configuration for closed-loop antenna selection provide solutions to such issues. For example, a UE may be configured to provide, e.g., to a base station, gNB, etc., capability reporting associated with antenna selection architecture(s) of the UE (e.g., pCqA, where there are ‘p’ Tx chains and ‘q’ antenna ports, and where p>q; pCqA may include a number ‘p’ of Tx chains, where (p): (1), 2, 3, 4, and may include a number ‘q’ of antenna ports, where (q): (2), 3, 4, 6, 8. In some examples, a UE may be configured to provide connection capability(ies) between Tx chains and antenna ports and/or indications for consideration of carrier aggregation. In some examples, SRS configuration for AS may be utilized, e.g., based on the capability reporting. For instance, SRS-based uplink beam management procedures may be reused, antenna switching SRS configuration may be reused, explicit configurations with antenna indices for each SRS resource may be used, implicit rule to derive AS SRS configurations may be used, and/or time-domain implicit antenna switching based on AS may be used. In some examples, a UE may perform AS operations based network-generated parameters, e.g., calculated based on AS SRS measurements, and a network node may perform AS operations based on UE assistance information and AS SRS measurements. The described aspects provide closed-loop UL AS support by enabling a UE and the network to cooperatively choose the best set of antennas based on SRS. The described aspects also enable closed-loop antenna selection in NR with CB- or NCB-based uplink MIMO by enabling a UE and the network to cooperatively choose the best set of antennas based on SRS. Accordingly, aspects herein enable a UE and the network to cooperatively choose the best set of antennas based on SRS, such as via UE capability reporting, SRS configuration for AS, and AS operations, and thus provide closed-loop UL AS support.

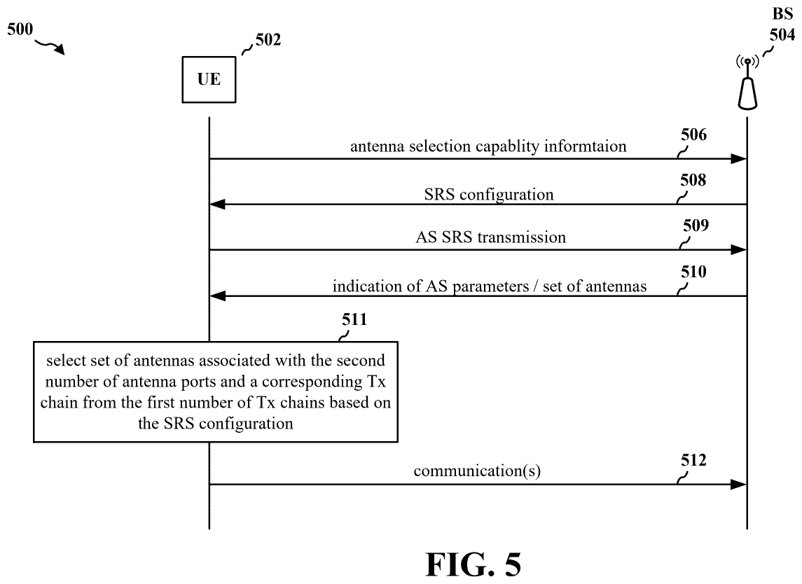

FIG. 5 is a call flow diagram 500 for wireless communications, in various aspects. Call flow diagram 500 illustrates UE capability and SRS configuration for closed-loop AS for a wireless device (a UE 502, by way of example) that communicates with a network node which may comprise one or more network nodes (e.g., a base station 504, such as a gNB or other type of base station or a DU(s), by way of example, as shown and described herein), in various aspects. Aspects described for the base station 504, and for network nodes herein, generally, may be performed in aggregated form and/or by one or more components in disaggregated form. Additionally, or alternatively, the aspects may be performed by the UE 502 autonomously, in addition to, and/or in lieu of, operations of the base station 504.

For UL AS, the UE 502 may report the number of Tx chains (or MIMO streams) that can be simultaneously transmitted, as well as the number of antenna ports through which signals from the Tx chains can be transmitted. Such AS capability may be denoted as “pCqA,” as noted above, where ‘p’ is the number of Tx chains, and ‘q’ is the number of antenna ports (e.g., p∈{(1), 2, 3, 4} and q∈{(2), 3, 4, 6, 8}). The pCqA may be equivalent to xTyR for NR antenna switching, which may be utilized, in various aspects. However, aspects herein also provide for beneficial and separate reporting (e.g., via pCqA) for flexibility, such as to support the combination of open-loop AS and closed-loop AS. Such AS capability may be defined per component carrier/component carrier combination as different carrier aggregation configurations may result in different antenna capability(ies). Additionally, as described herein, Tx chains and/or antenna ports may not explicitly be physical RF chains and antennas, but may reference a virtualized concept. For example, in aspects, a Tx chain may be a port that can be spatially multiplexed with another, and an antenna port may be a port that can create a channel to be independently measured by a receiver.

In the illustrated aspect, the UE 502 may be configured to provide/transmit, and the base station 504 may be configured to receive, antenna selection capability information 506. In aspects, the antenna selection capability information 506 may be based on a first number of Tx chains at the UE 502 and a second number of antenna ports at the UE 502. In aspects, the UE 502 may be configured to transmit/provide the antenna selection capability information 506, for the base station 504, as including assistance information associated with a set of UE-generated antenna selection parameters. In aspects, the antenna selection capability information 506 may be indicative of at least one of per-component carrier (CC) information or per-CC combination information for the first number of Tx chains at the UE 502 and the second number of antenna ports at the UE 502.

The antenna selection capability information 506 may be indicative of connection information. In aspects, the connection information may include at least one of the following. In one example, the connection information may include a sub-connection in which each Tx chain from the first number of Tx chains is configured to connect with disjoint antenna port sets from the second number of antenna ports. In one example, the connection information may include a partially joint connection in which a common set of antenna ports from the second number of antenna ports is connected to multiple Tx chains from the first number of Tx chains. In one example, the connection information may include a full connection in which each Tx chain from the first number of Tx chains is configured to connect with any antenna port from the second number of antenna ports.

In some aspects, each Tx chain in the first number of Tx chains is associated with a set of antenna port indices, where each index of the set of antenna port indices is indicative of a set of antenna ports to which an associated Tx chain is configured to connect. In such aspects, the UE 502 may be configured to provide/transmit the antenna selection capability information 506 as including the set of antenna port indices. In some aspects, the connection information may include at least one reference to a connections data structure, where the connections data structure may include an association between sets of antenna port indices and each Tx chain in the first number of Tx chains. In such aspects, the UE 502 may be configured to provide/transmit the antenna selection capability information 506 as including the at least one reference to the connections data structure. In some aspects, the connection information may include combination information. In such aspects, the combination information may include a number of antenna ports for which subsets of Tx chain combinations from the first number of Tx chains are configured to connect. In such aspects, the UE 502 may be configured to provide/transmit the antenna selection capability information 506 as including the combination information.

In some aspects, the UE 502 may be configured to transmit the antenna selection capability information 506 as including an antenna switching gap associated with SRS transmissions. In such aspects, the antenna switching gap may be per-UE, per-Tx chain, or per-connection. That is, the antenna switching gap may be defined as being be per-UE, per-Tx chain, or per-connection, in various aspects. In such aspects, the base station 504 may be configured, such as through an AS SRS in accordance with the SRS configuration 508, to guarantee a switching gap between SRS transmission occasions (e.g., the UE 502 may not be expected to transmit subsequent AS SRS resources within the switching gap from the previous SRS transmission).

The UE 502 may be configured to receive, and the base station 504 may be configured to provide/transmit, an SRS configuration 508. In aspects, the UE 502 may be configured to receive, and the base station 504 may be configured to provide/transmit, the SRS configuration 508 based on the antenna selection capability information 506. The SRS configuration 508 may be indicative of a set of SRS resources for the first number of Tx chains at the UE 502 and the second number of antenna ports at the UE 502 associated with the first number of Tx chains for antenna selection. In aspects, the SRS configuration 508 may be indicative of a set of antenna selection parameters associated with SRS antenna selection for the set of SRS resources. In aspects, the SRS configuration 508 may be indicative of the set of antennas associated with the second number of antenna ports and the corresponding Tx chain from the first number of Tx chains.

In aspects, the SRS configuration 508 may be associated with an UL beam management procedure and may be indicative of a set of SRS resources, each SRS resource with ‘p’ antenna ports may be associated with the first number of Tx chains based on a condition for the UL beam management procedure. In aspects, the SRS configuration 508 may be associated with antenna switching SRS resource set which has q/p SRS resources each with p ports, where ‘p’ ports of each SRS resource may be associated with different ‘p’ antenna ports of the second number of antenna ports. In aspects, the SRS configuration 508 may be associated with SRS antenna selection for the set of SRS resources and may be indicative of an association between sets of antenna port indices and each Tx chain in the first number of Tx chains. In aspects, the SRS configuration 508 may be associated with SRS antenna selection for the set of SRS resources. In such aspects, the number of SRS resources in the set is determined as

$${max}_{i = 0 , … p - 1} {N}_{{c}_{i}} ,$$

where N_{c}_{ᵢ} is the number of antennas ports connected to the i^{th} chain according to the antenna selection capability information. Each SRS resource of the set of SRS resources may have a respective number of ports of which the n^{th} port may be associated with the n^{th} antenna port connected to each chain of the first number of Tx chains. In one example, each SRS resource has the respective number of ports having a maximum number of antenna port connections. In another example, the respective number of ports being associated with a cyclical sweep of the maximum number of antenna port connections. In aspects, the SRS configuration 508 may be associated with SRS antenna selection for the set of SRS resources based on a periodic mapping in a time domain. In such aspects, the periodic mapping may be an SRS resource port-to-antenna mapping, and (i) the SRS configuration may be indicative of the periodic mapping or (ii) a number of ports of an SRS resource of the set of SRS resources may be associated with a cyclical sweep of a maximum number of antenna port connections for the SRS resource.

The UE 502 may be configured to transmit/provide, and the base station 504 may be configured to receive, an AS SRS transmission 509 in accordance with the AS SRS configuration (e.g., the SRS configuration 508).

The base station 504 may be configured to acquire/obtain SRS measurements based on a reception of the AS SRS transmission 509. In aspects, based on the SRS measurements, the base station 504 may be configured to calculate/generate AS-related parameters (e.g., antenna selection parameters) and to provide such information to the UE 502 as an indication 510. Based on AS-related parameters, the UE 502 may be configured to select/identify/determine the best set of antennas to be connected to the first number of Tx chains. For example, the UE 502 may be configured to select (at 511) a set of antennas associated with the second number of antenna ports and a corresponding Tx chain from the first number of Tx chains based on the SRS configuration 508, and in aspects, the selection (at 511) may be based on the AS parameters. In some aspects, based on the SRS measurements, the base station 504 may be configured to select/identify/determine the best set of antennas, e.g., the set of antennas, to be connected to the first number of Tx chains, and to provide such information to the UE 502, which may be configured to receive such information, as the indication 510. For example, the UE 502 may be configured to select (at 511) the set of antennas associated with the second number of antenna ports and the corresponding Tx chain from the first number of Tx chains based on the SRS configuration 508 for the antenna selection and the set of antenna selection parameters associated with the SRS antenna selection for the set of SRS resources.

The UE 502 and the base station 504 may be configured to communicate (e.g., transmit/provide, receive, and/or exchange one or more communications 512) in accordance with the best set of antennas connected to the first number of Tx chains, e.g., subsequent to the selection.

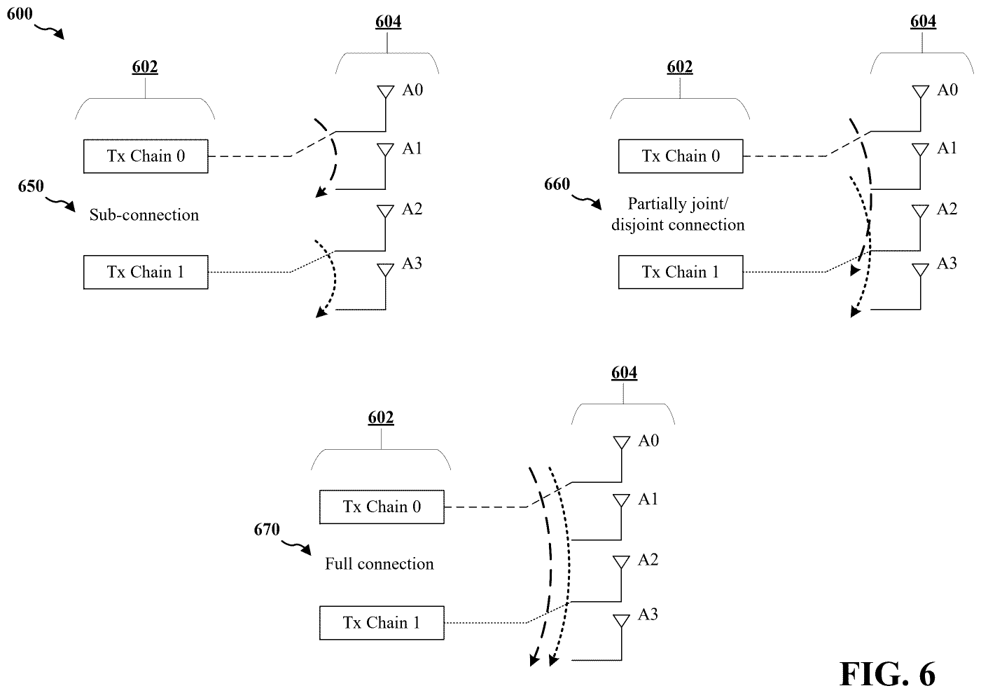

FIG. 6 is a diagram 600 illustrating an example of UE capability reporting for AS architectures, in various aspects. Diagram 600 shows a first number of Tx chains 602 (e.g., at a UE, such as the UE 502 in FIG. 5) in configurations for which various connections may be configured to a second number of antenna ports 604 (e.g., at a UE, such as the UE 502 in FIG. 5). Diagram 600 shows three such connections.

A configuration 650 is illustrated for a sub-connection. In a sub-connection, each Tx chain of the first number of Tx chains 602 may have a connection with a disjoint set of the second number of antenna ports 604. In the example shown, an antenna port A0 and an antenna port A1 (e.g., 2 ports) may be connected to for a Tx chain 0 of the first number of Tx chains 602, while an antenna port A2 and an antenna port A3 (e.g., 2 ports) may be connected to for a Tx chain 1 of the first number of Tx chains 602. This may be referenced as a 2+2 configuration for a 2C4A case, where p=2 and q=4 for pCqA. Aspects also include 1+3 configurations in 2C4A cases, such as where the antenna port A0 may be connected to by the Tx chain 0, without other possible connections, and the antenna ports A1, A2, and A3 may be connected to by the Tx chain 1.

A configuration 660 is illustrated for a partially joint/disjoint connection. In a partially joint/disjoint connection, a subset of the antenna ports may be connected to multiple Tx chains of the first number of Tx chains 602. As one example, a 3+3 configuration in 2C4A case is shown where the Tx chain 0 may have a connection for the antenna ports A0, A1, and A2 (3 ports), while the Tx chain 1 may have a connection for the antenna ports A1, A2, and A3 (3 ports).

A configuration 670 is illustrated for a full connection. In a full connection, all Tx chains of the first number of Tx chains 602 may be connected to the all antenna ports, e.g., ports A0, A1, A2, and A3 (4 ports), of the second number of antenna ports 604 for each of Tx chain 0/Tx chain 1, e.g., a 4+4 configuration in this 2C4A case.

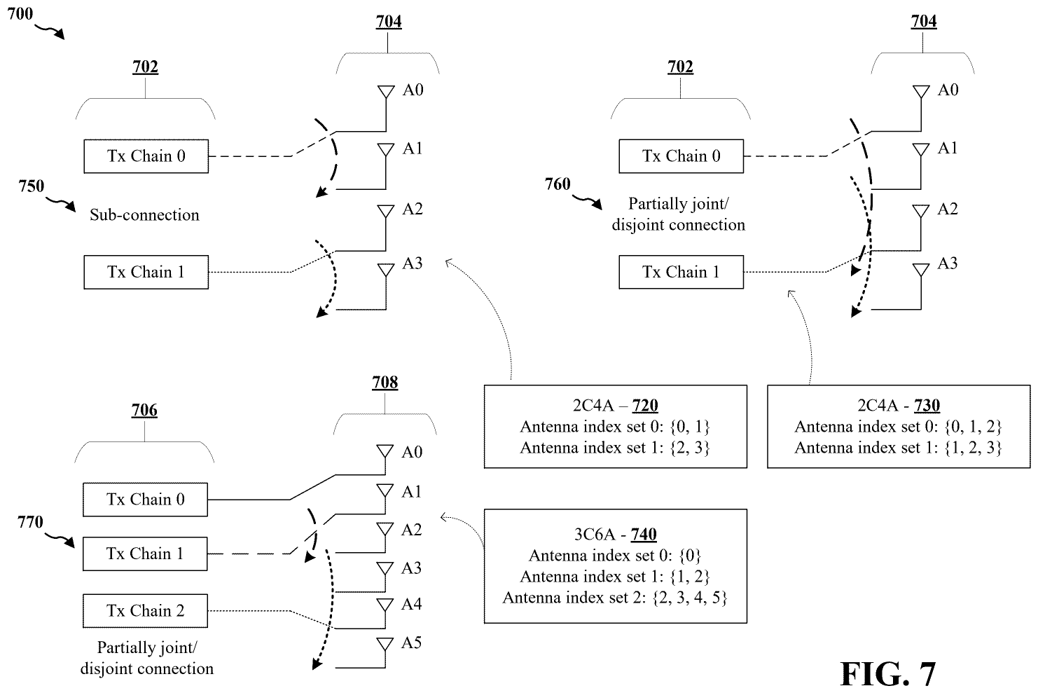

FIG. 7 is a diagram 700 illustrating an example of UE capability reporting for AS architectures, in various aspects. Diagram 700 shows a configuration 750 and a configuration 760 for a first number of Tx chains 702 (e.g., at a UE, such as the UE 502 in FIG. 5) in configurations for which various connections may be configured to a second number of antenna ports 704 (e.g., at a UE, such as the UE 502 in FIG. 5). Diagram 700 also shows a configuration 770 for a first number of Tx chains 706 (e.g., at a UE, such as the UE 502 in FIG. 5) in configurations for which various connections may be configured to a second number of antenna ports 708 (e.g., at a UE, such as the UE 502 in FIG. 5).

Each configuration in diagram 700 may illustrate UE capability report for UL AS in the context of a UE reporting information associated with Tx chain-to-antenna port connections (e.g., as further aspects to those described for the antenna selection capability information 506 in FIG. 5 and the configurations in FIG. 6). For example, antenna indices corresponding to various antenna ports of the second number of antenna ports 704 or the second number of antenna ports 708, which may be connected to each Tx chain of the first number of Tx chains 702 or the first number of Tx chains 706, may be reported to a network node (e.g., a base station, gNB, etc.), with pCqA information, as described above. In the case of pCqA configurations, a UE connection capability may include ‘p’ sets of antenna indices in {0, 1, . . . , q−1}, and each of the ‘p’ sets may indicate antenna indices connected to each Tx chain. Aspects also include optimization, or not, for such reporting in antenna selection capability information. That is, reporting may be non-optimized and may include, or not, redundant connection cases (e.g., such as 2C4A with {1} and {2, 3}).

The configuration 750 may be for a sub-connection in a 2C4A case or pCqA. In the context of utilizing a set of indices as part of antenna selection capability information, e.g., the antenna selection capability information 506 in FIG. 5, a set of antenna port indices 720 is shown as an antenna index set 0: {0, 1}(corresponding to the antenna ports A0 and A1), and as an antenna index set 1: {2, 3} (corresponding to the antenna ports A2 and A3). Such sets of antenna port indices, e.g., 0 and 1, may respectively correspond to the Tx chain 0 and the Tx chain 1 of the first number of Tx chains 702. Some or all of such information for the set of antenna port indices 720 may be provided with, or in addition to, antenna selection capability information, in various aspects.

The configuration 760 may be for a partially joint/disjoint connection in a 2C4A case or pCqA. Similarly, for utilizing a set of indices as part of antenna selection capability information, e.g., the antenna selection capability information 506 in FIG. 5, a set of antenna port indices 730 is shown as an antenna index set 0: {0, 1, 2} (corresponding to the antenna ports A0, A1, and A2), and as an antenna index set 1: {1, 2, 3} (corresponding to the antenna ports A1, A2, and A3), may respectively correspond to the Tx chain 0 and the Tx chain 1 of the first number of Tx chains 702. Some or all of such information for the set of antenna port indices 730 may be provided with, or in addition to, antenna selection capability information, in various aspects.

The configuration 770 may be for a partially joint/disjoint connection in a 3C6A case or pCqA. Again, for utilizing a set of indices as part of antenna selection capability information, e.g., the antenna selection capability information 506 in FIG. 5, a set of antenna port indices 740 is shown as an antenna index set 0: {0} (corresponding to the antenna port A0 of the second number of antenna ports 708), as an antenna index set 1: {1, 2} (corresponding to the antenna ports A1 and A2 of the second number of antenna ports 708), and as an antenna index set 2: {2, 3, 4, 5} (corresponding to the antenna ports A2, A3, A4, and A5 of the second number of antenna ports 708), may respectively correspond to the Tx chain 0 and the Tx chain 1 of the first number of Tx chains 706. Some or all of such information for the set of antenna port indices 730 may be provided with, or in addition to, antenna selection capability information, in various aspects.

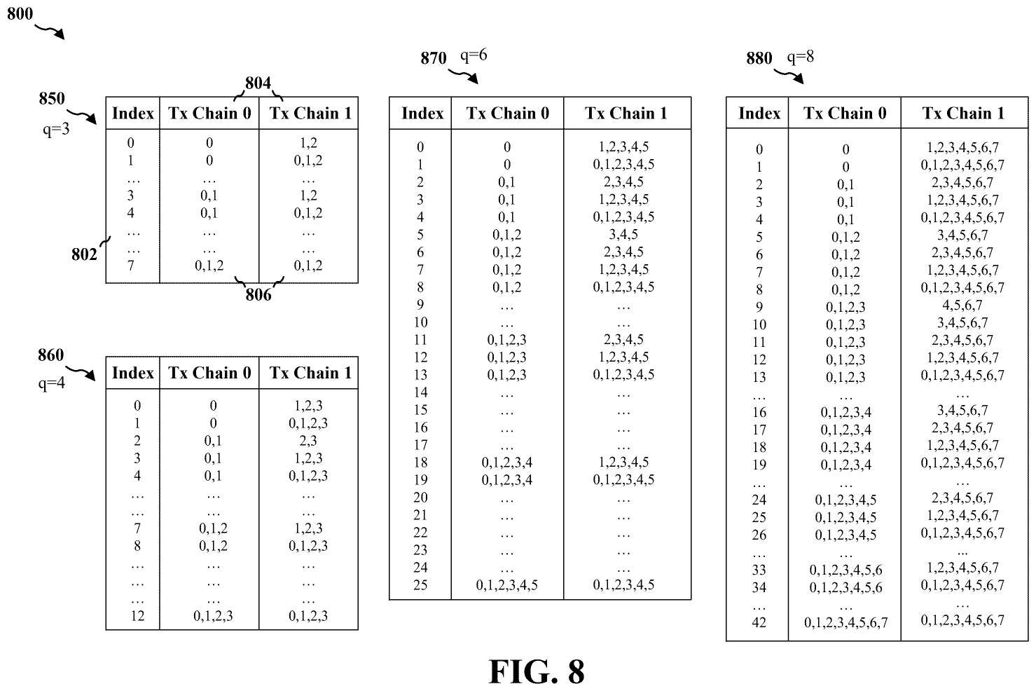

FIG. 8 is a diagram 800 illustrating an example of UE capability reporting for AS architectures, in various aspects. Diagram 800 shows a configuration 850, a configuration 860, a configuration 870, and a configuration 880, each of which represents, by way of example, a connections data structure that may be configured/defined (e.g., by standardization) connection information associated with a first number of Tx chains 804 (e.g., at a UE, such as the UE 502 in FIG. 5) for which various connections may be configured to a second number of antenna ports 806 (e.g., at a UE, such as the UE 502 in FIG. 5). That is, diagram 800 is shown in the context of a UE reporting additional information to a network node, such as Tx chain-to-antenna port connections for UL AS.

In aspects, a connections data structure or a data structure, generally, may be non-specifically formatted information, a table, a list, a database, delineated data, tabulated data, and/or the like. While the representations in FIG. 8 are shown as connections tables, aspects herein are not so limited, and diagram 800 is shown and described, by way of example, for illustrative clarity and brevity of description. The illustrated aspects also show optimizations via the ellipses (‘ . . . ’) for various columns of a given Tx chain instead of duplicate Tx chain-to-antenna port connections. In some aspects, if the connections data structure design is subject a certain restriction such as transmission overhead, storage overhead, scenarios where sub-connections are allowed but other connections are not, an equal number of antenna ports per Tx chain is allowed, a maximum number of antenna ports per Tx chain is known, and/or the like, then some rows may be deemed unnecessary and may be omitted.

Each row of the connections data structures shown lists antenna port indices connected to each Tx chain, and a UE may be configured to report at least one of a reference/index 802 of a row(s) corresponding to the connection capability of the UE.

Each representation of a data structure in diagram 800 is associated with a respective value for ‘q’ (e.g., the number of available antenna ports: A0, A1, . . . , AN) in accordance with a pCqA case: q=3 in the configuration 850, q=4 in the configuration 860, q=6 in the configuration 870, and q=8 in the configuration 880. Each row in the illustrated configurations may be associated with the reference/index 802. In aspects, such as when a data structure is configured/defined and known to a UE and a network node, the UE may provide the reference/index 802 to the network node with, or in addition to, antenna selection capability information (e.g., the antenna selection capability information 506 in FIG. 5). Providing or transmitting instances of the reference/index 802 (e.g., at least one reference to a connections data structure) may thus inform the network node that the UE has capabilities, for each Tx chain in the data structure, to make connections with the corresponding sets of antenna ports.

In some aspects, a number of AS cases for each row of a connections data structure may be calculated/obtained as Πᵢ₌₁^{p}N_{c}_{ᵢ}, if overlap is allowed, and as Πᵢ₌₁^{p}N_{c}_{ᵢ}−O, otherwise, where O is the number of cases overlapped for a selection.

In some aspects for additional UE reporting of Tx chain-to-antenna port connections, a UE may be configured to provide/transmit the number of antenna ports connected to each subset of Tx chains. As one example, a 2CqA case may be considered. In such as case, the number of antenna ports connected individually to each Tx chain (A0, A1) and the number of antenna ports connected to two Tx chains (A01) may be utilized.

As another example, a 3CqA case may be considered. In such a case, the number of antenna ports connected individually to each Tx chain (A0, A1, A2), the number of antenna ports connected to two Tx chains (A01, A02, A12), and the number of antenna ports connected to three Tx chains (A012) may be utilized. For instance, where p=3 and q=6 in a 3CqA case, A0=2, A1=1, A2=1, A01=1, A02=0, A12=0, and A012=1. Thus, Tx chain 0 is connected to antenna ports 0, 1, 2, 3, Tx chain 1 is connected to antenna ports 3, 4, and Tx chain 2 is connected to antenna ports 3, 5.

As another example, a 4CqA case may be considered. In such a case, the number of antenna ports connected individually to each Tx chain (A0, A1, A2, A3), the number of antenna ports connected to two Tx chains (A01, A02, A03, A12, A13, A23), the number of antenna ports connected to three Tx chains (A012, A013, A023, A123), and the number of antenna ports connected to four chains (A0123) may be utilized. For instance, where p=4 and q=8 in a 4CqA case, A_{w}=(1, 1, 1, 1), A_{wx}=(1, 0, 0, 1, 0, 0), A_{wxy}=(1, 0, 0, 0), and A_{wxyz}=(1). Thus, Tx chain 0 is connected to antenna 0, 1, 2, 3, Tx chain 1 is connected to antenna 1, 2, 3, 4, 5, Tx chain 2 is connected to antenna 2, 3, 5, 6, and Tx chain 3 is connected to antenna 4, 7.

In aspects, if sub-connections are supported in the system, and other connections are not, the number of antenna ports connected individually to each Tx chain (A0, . . . Ap) may be enough to define the connections.

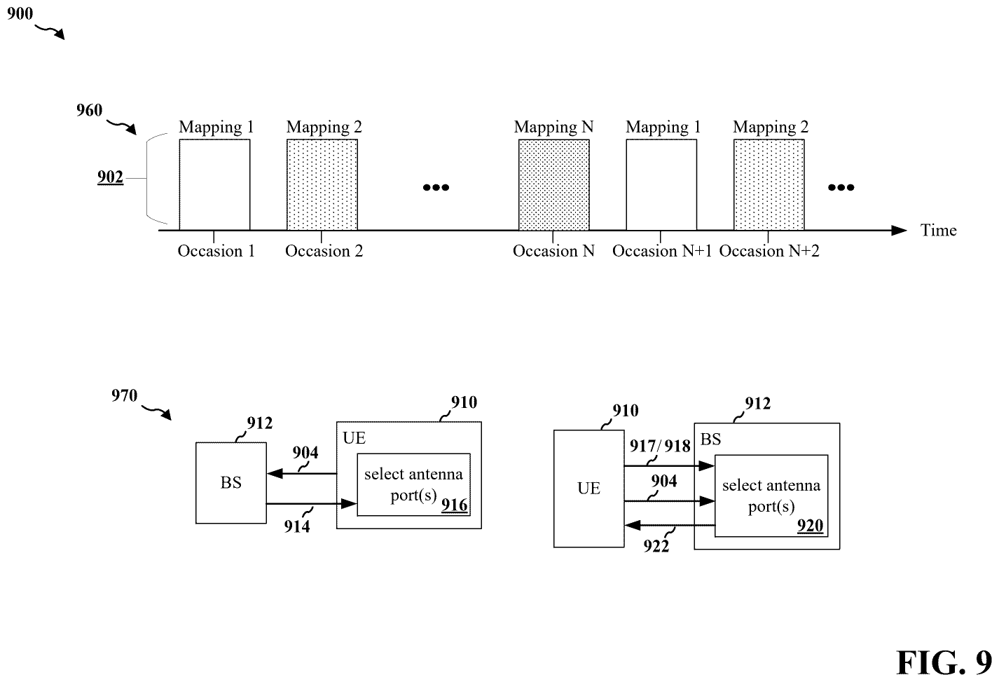

FIG. 9 is a diagram 900 illustrating an example of SRS configuration for AS, in various aspects. Diagram 900 shows a configuration 960, and a configuration 970, each of which represents, by way of example, mechanisms for network node-based SRS configuration for AS, or for SRS resources for AS, in the context of pCqA.

In some aspects, SRS-based uplink beam management procedure(s) may be reused/repurposed for network node-based SRS configurations. For instance, one SRS resource set containing a number N of p-port SRS resources may be configured and transmitted/provided for AS, where N corresponds to the number of AS cases. The network node may select the best SRS resource and indicate the corresponding index to the UE. In such aspects, sophisticated AS architecture capability reporting may be unused or disregarded, as capability reporting on the number of ports (e.g., corresponding to p) and the number of AS cases may be sufficient (e.g., while additional SRS resources may be utilized for cases of large p and/or large q).

In some aspects, an antenna switching SRS configuration may be reused/repurposed for network node-based SRS configurations. For instance, in the context of xTyR (x number of transmitters and y number of receivers), each SRS resource set may have y/x SRS resources transmitted in different symbols each with x ports, each x ports of each SRS resource may be associated with a different UE antenna port, and NR may support cases where y is a multiple of x but may not support other cases. If antenna switching SRS is reused/repurposed for AS, according to aspects, it may be assumed that each Tx chain is connected at least y/x antenna ports. Such aspects may not support the case of Tx chain-to-antenna port connection being swapped, which may provide different insertion loss (e.g., the connection (C0-A1, C1-A0) may provide different insertion loss than the connection (C0-A0, C1-A1)).

In some aspects, AS SRS may be configured with explicit antenna port indices corresponding to each SRS port of the resources, and may be utilized when AS SRS resource sets are configured. For example, in a 2C4R case of pCqA with a connection (0, 1) for the first Tx chain and a connection (1, 2, 3) for the second Tx chain, the SRS resource 0 with two ports may be connected to antenna port indices (0, 1), the SRS resource 1 with two ports may be connected to antenna port indices (1, 2), and the SRS resource 2 with single port may be connected to antenna port index 3 (or two ports connected to antenna port indices (0, 3)).

In some aspects, an implicit rule may be utilized to derive the SRS configuration. For example, a number of SRS resources in an AS SRS resource set may be provided as

$$( N ) = {max}_{i = 0 , … p - 1} {N}_{{c}_{i}} ,$$

where N_{c}_{ᵢ} is the number of antenna ports connected to Tx chain-i (Cᵢ). The k^{th} port of the SRS resource sweeps all antenna ports connected to the k^{th} chain, e.g., the n^{th} SRS resource (Sₙ) may have at least one the following port-mappings. In one example, the n^{th} SRS resource has up to p ports and discard the port when there is no n^{th} antenna port connected to the k^{th} Tx chain, e.g.,

$${S}_{n} = ( {a}_{0} ( n ) , {a}_{1} ( n ) , … , {a}_{p - 1} ( n ) ) ,$$

where aₖ(n) is the n^{th} antenna port connected to the k^{th} Tx chain and aₖ(n) null if n>N_{c}_{ₖ}. In another example, the n^{th} SRS resource has p ports sweeping in a cycling manner, e.g.,

$${S}_{n} = ( {a}_{0} ( n mod {N}_{{c}_{0}} ) , {a}_{1} ( n mod {N}_{{c}_{1}} ) , … , {a}_{p - 1} ( n mod {N}_{{c}_{p - 1}} ) ) .$$

In the configuration 960, a time-domain implicit antenna switching for AS is shown. A single SRS resource may be configured for AS, which has p-port. A port-to-antenna mapping (e.g., shown as SRS resource port-to-antenna mappings 902) may be determined/calculated/obtained by SRS transmission time in a periodic manner, according to aspects. The period of port-to-antenna mapping may be between occasions thereof, and may be shown as:

$$N = {max}_{i = 0 , … p - 1} {N}_{{c}_{i}} ,$$

where N_{c}_{ᵢ} is the number of antenna ports connected to Tx chain-i (Cᵢ). In aspects, N different port-to-antenna mappings may be explicitly indicated by a network node (e.g., as described above) or may be implicitly determined (e.g., as described above). As one example, for explicit indication in a 2C4A case with a connection (0, 1) for the first Tx chain and a connection (1, 2, 3) for the second Tx chain, N=3. Here, for the first mapping: two ports are connected to antenna port indices (0, 1), for the second mapping: two ports are connected to antenna port indices (1, 2), and for the third mapping: two ports are connected to antenna port indices (0, 3). As another example, for implicit indication in a 2C4A case, the k^{th} port of the SRS resource may sweep each antenna port connected to the k^{th} Tx chain:

$${S}_{n} = ( {a}_{0} ( n mod {N}_{{c}_{0}} ) , {a}_{1} ( n mod {N}_{{c}_{1}} ) , … , {a}_{p - 1} ( n mod {N}_{{c}_{p - 1}} ) ) , n = 0 , … , N .$$

In some aspects, the UE may report an antenna switching gap for AS SRS transmission(s). In such aspects, the antenna switching gap may be per-UE, per-Tx chain, or per-connection. That is, the antenna switching gap may be defined as being be per-UE, per-Tx chain, or per-connection, in various aspects. In such aspects, the network node may be configured to guarantee a switching gap between SRS transmission occasions (e.g., the UE may not be expected to transmit subsequent AS SRS resources within the switching gap from the previous SRS transmission).

In the configuration 970, aspects are shown for obtaining a best connection between a Tx chain and an antenna port(s) based on AS SRS. In some aspects, based on an AS SRS transmission 904 from UE 910 according to an AS SRS configuration (e.g., SRS configuration 508 in FIG. 5), a base station 912 may be configured to calculate a set of antenna selection parameters 914 associated with SRS antenna selection for a set of SRS resources. A base station 912 (e.g., a network node) may be configured to transmit/provide, and a UE 910 may be configured to receive/obtain, the set of antenna selection parameters 914 associated with SRS antenna selection for a set of SRS resources. In such aspects as described herein, the UE 910 may be configured to select (at 916) the set of antenna ports of the second number of antenna ports connected to the first number of Tx chains based on the set of antenna selection parameters 914 associated with the SRS antenna selection for the set of SRS resources. In aspects, the set of antenna selection parameters 914 may include, without limitation, a per-antenna SRS-reference signal received power (RSRP), which may be included in UL measurement reporting.

In other aspects, the UE 910 may be configured to transmit the antenna selection capability information as including, for the network node (e.g., to the base station 912), assistance information 917 associated with a set of UE-generated antenna selection parameters 918, and the AS SRS transmission 904. The base station 912 may be configured to select (at 920) antenna ports based on the assistance information 917 associated with a set of UE-generated antenna selection parameters 918 and the SRS transmission 904. The base station 912 may be configured to transmit/provide, and the UE 910 may be configured to receive, an indication 922 of the set of antenna ports of the second number of antenna ports connected to the first number of Tx chains. In aspects, the set of UE-generated antenna selection parameters 918 may include, without limitation, a per-antenna PHR.

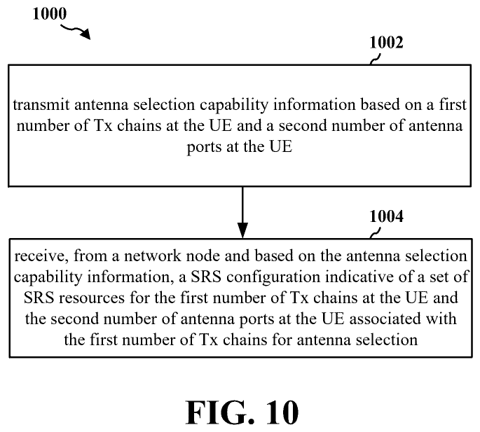

FIG. 10 is a flowchart 1000 of a method of wireless communication. The method may be performed by a UE (e.g., the UE 104, 502, 910; the apparatus 1404). The method may be for UE capability and SRS configuration for closed-loop antenna selection. The method may provide for enabling a UE and a network to cooperatively choose the best set of antennas based on SRS, such as via UE capability reporting, SRS configuration for AS, and AS operations, and thus provide closed-loop UL AS support.

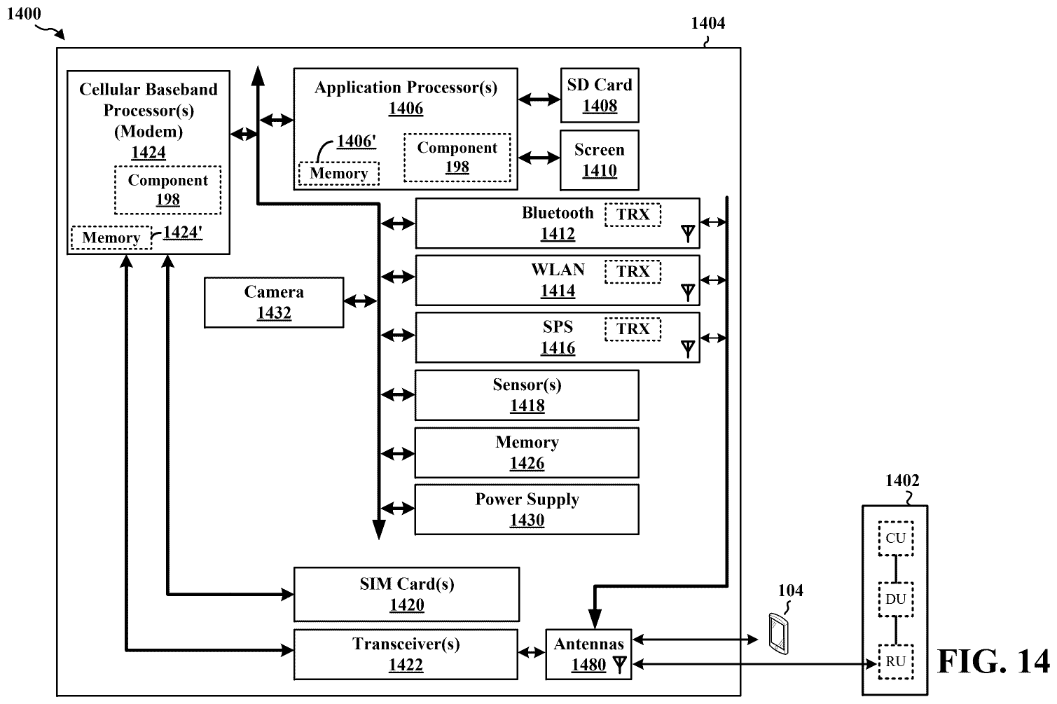

At 1002, the UE transmits antenna selection capability information based on a first number of Tx chains at the UE and a second number of antenna ports at the UE. As an example, the transmission may be performed by one or more of the component 198, the transceiver(s) 1422, and/or the antennas 1480 in FIG. 14. FIG. 5 illustrates, in the context of FIGS. 6-9, an example of the UE 502 transmitting/providing such antenna selection capability information to/for a network node (e.g., the base station 504).

The UE 502 may be configured to provide/transmit, and the base station 504 may be configured to receive, antenna selection capability information 506. In aspects, the antenna selection capability information 506 may be based on a first number of Tx chains (e.g., 602 in FIG. 6; 702, 706 in FIG. 7; 804 in FIG. 8) at the UE 502 and a second number of antenna ports (e.g., 604 in FIG. 6; 704, 708 in FIG. 7; 806 in FIG. 8) at the UE 502. In aspects, the UE 502 may be configured to transmit/provide the antenna selection capability information 506, for the base station 504, as including assistance information (e.g., 917 in FIG. 9) associated with a set of UE-generated antenna selection parameters (e.g., 918 in FIG. 9). In aspects, the antenna selection capability information 506 may be indicative of at least one of per-component carrier (CC) information or per-CC combination information for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502.

The antenna selection capability information 506 may be indicative of connection information. In aspects, the connection information may include at least one of the following. In one example, the connection information may include a sub-connection (e.g., 650 in FIG. 6; 750 in FIG. 7) in which each Tx chain from the first number of Tx chains (e.g., 602 in FIG. 6; 702, 706 in FIG. 7; 804 in FIG. 8) is configured to connect with disjoint antenna port sets from the second number of antenna ports (e.g., 604 in FIG. 6; 704, 708 in FIG. 7; 806 in FIG. 8). In one example, the connection information may include a partially joint connection (e.g., 660 in FIG. 6; 760, 770 in FIG. 7) in which a common set of antenna ports from the second number of antenna ports (e.g., 604 in FIG. 6; 704, 708 in FIG. 7; 806 in FIG. 8) is connected to multiple Tx chains from the first number of Tx chains (e.g., 602 in FIG. 6; 702, 706 in FIG. 7; 804 in FIG. 8). In one example, the connection information may include a full connection (e.g., 670 in FIG. 6) in which each Tx chain from the first number of Tx chains (e.g., 602 in FIG. 6; 702, 706 in FIG. 7; 804 in FIG. 8) is configured to connect with any antenna port from the second number of antenna ports (e.g., 604 in FIG. 6; 704, 708 in FIG. 7; 806 in FIG. 8).

In some aspects, each Tx chain in the first number of Tx chains (e.g., 602 in FIG. 6; 702, 706 in FIG. 7; 804 in FIG. 8) is associated with a set of antenna port indices (e.g., 720, 730, 740 in FIG. 7), where each index of the set of antenna port indices (e.g., 720, 730, 740 in FIG. 7) is indicative of a set of antenna ports to which an associated Tx chain is configured to connect. In such aspects, the UE 502 may be configured to provide/transmit the antenna selection capability information 506 as including the set of antenna port indices (e.g., 720, 730, 740 in FIG. 7). In some aspects, the connection information may include at least one reference to a connections data structure, where the connections data structure may include an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In such aspects, the UE 502 may be configured to provide/transmit the antenna selection capability information 506 as including the at least one reference to the connections data structure. In some aspects, the connection information may include combination information. In such aspects, the combination information may include a number of antenna ports (e.g., 604 in FIG. 6; 704, 708 in FIG. 7; 806 in FIG. 8) for which subsets of Tx chain combinations from the first number of Tx chains (e.g., 602 in FIG. 6; 702, 706 in FIG. 7; 804 in FIG. 8) are configured to connect. In such aspects, the UE 502 may be configured to provide/transmit the antenna selection capability information 506 as including the combination information.

In some aspects, the UE 502 may be configured to transmit the antenna selection capability information 506 as including an antenna switching gap associated with SRS transmissions. In such aspects, the antenna switching gap may be per-UE, per-Tx chain, or per-connection. That is, the antenna switching gap may be defined as being be per-UE, per-Tx chain, or per-connection, in various aspects. In such aspects, the base station 504 may be configured, such as through an AS SRS in accordance with the SRS configuration 508, to guarantee a switching gap between SRS transmission occasions (e.g., the UE 502 may not be expected to transmit subsequent AS SRS resources within the switching gap from the previous SRS transmission).

At 1004, the UE receives, from a network node and based on the antenna selection capability information, a SRS configuration indicative of a set of SRS resources for the first number of Tx chains at the UE and the second number of antenna ports at the UE associated with the first number of Tx chains for antenna selection. As an example, the reception may be performed by one or more of the component 198, the transceiver(s) 1422, and/or the antennas 1480 in FIG. 14. FIG. 5 illustrates, in the context of FIGS. 6-9, an example of the UE 502 receiving such a SRS configuration from a network node (e.g., the base station 504).

The UE 502 may be configured to receive, and the base station 504 may be configured to provide/transmit, an SRS configuration 508. In aspects, the UE 502 may be configured to receive, and the base station 504 may be configured to provide/transmit, the SRS configuration 508 based on the antenna selection capability information 506. The SRS configuration 508 may be indicative of a set of SRS resources for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502 associated with the first number of Tx chains (e.g., 602 in FIG. 6; 702, 706 in FIG. 7; 804 in FIG. 8) for antenna selection. In aspects, the SRS configuration 508 may be indicative of a set of antenna selection parameters (e.g., 918 in FIG. 9) associated with SRS antenna selection for the set of SRS resources. In aspects, the SRS configuration 508 may be indicative of the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8).

In aspects, the SRS configuration 508 may be associated with an UL beam management procedure and may be indicative of a set of SRS resources, each SRS resource with ‘p’ antenna ports may be associated with the first number of Tx chains (e.g., 602 in FIG. 6; 702, 706 in FIG. 7; 804 in FIG. 8) based on a condition for the UL beam management procedure. In aspects, the SRS configuration 508 may be associated with antenna switching SRS resource set which has q/p SRS resources each with p ports, where ‘p’ ports of each SRS resource may be associated with different ‘p’ antenna ports of the second number of antenna ports (e.g., 604 in FIG. 6; 704, 708 in FIG. 7; 806 in FIG. 8). In aspects, the SRS configuration 508 may be associated with SRS antenna selection for the set of SRS resources and may be indicative of an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In aspects, the SRS configuration 508 may be associated with SRS antenna selection for the set of SRS resources. In such aspects, the number of SRS resources in the set is determined as

$${max}_{i = 0 , … p - 1} {N}_{{c}_{i}} ,$$

where N_{c}_{ᵢ} is the number of antennas ports connected to the i^{th} chain according to the antenna selection capability information. Each SRS resource of the set of SRS resources may have a respective number of ports of which the n^{th} port may be associated with the n^{th} antenna port connected to each chain of the first number of Tx chains (e.g., 602 in FIG. 6; 702, 706 in FIG. 7; 804 in FIG. 8). In one example, each SRS resource has the respective number of ports having a maximum number of antenna port connections. In another example, the respective number of ports being associated with a cyclical sweep of the maximum number of antenna port connections. In aspects, the SRS configuration 508 may be associated with SRS antenna selection for the set of SRS resources based on a periodic mapping in a time domain. In such aspects, the periodic mapping may be an SRS resource port-to-antenna mapping (e.g., 902 in FIG. 9), and (i) the SRS configuration may be indicative of the periodic mapping or (ii) a number of ports of an SRS resource of the set of SRS resources may be associated with a cyclical sweep of a maximum number of antenna port connections for the SRS resource.

The UE 502 may be configured to transmit/provide, and the base station 504 may be configured to receive, an AS SRS transmission 509 (e.g., 904 in FIG. 9) in accordance with the AS SRS configuration (e.g., the SRS configuration 508).

The base station 504 may be configured to acquire/obtain SRS measurements based on a reception of the AS SRS transmission 509 (e.g., 904 in FIG. 9). In aspects, based on the SRS measurements, the base station 504 may be configured to calculate/generate AS-related parameters (e.g., antenna selection parameters (e.g., 918 in FIG. 9)) and to provide such information to the UE 502 as an indication 510 (e.g., 914, 922 in FIG. 9). Based on AS-related parameters, the UE 502 may be configured to select/identify/determine the best set of antennas to be connected to the first number of Tx chains (e.g., 602 in FIG. 6; 702, 706 in FIG. 7; 804 in FIG. 8). For example, the UE 502 may be configured to select (at 511) (e.g., 916 in FIG. 9) a set of antennas associated with the second number of antenna ports (e.g., 604 in FIG. 6; 704, 708 in FIG. 7; 806 in FIG. 8) and a corresponding Tx chain from the first number of Tx chains (e.g., 602 in FIG. 6; 702, 706 in FIG. 7; 804 in FIG. 8) based on the SRS configuration 508, and in aspects, the selection (at 511) (e.g., 916 in FIG. 9) may be based on the AS parameters. In some aspects, based on the SRS measurements, the base station 504 may be configured to select/identify/determine (e.g., 920 in FIG. 9) the best set of antennas, e.g., the set of antennas, to be connected to the first number of Tx chains (e.g., 602 in FIG. 6; 702, 706 in FIG. 7; 804 in FIG. 8), and to provide such information to the UE 502, which may be configured to receive such information, as the indication 510 (e.g., 914, 922 in FIG. 9). For example, the UE 502 may be configured to select (at 511) (e.g., 916 in FIG. 9) the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8) based on the SRS configuration 508 for the antenna selection and the indication of the set of antennas (e.g., 918 in FIG. 9) associated with the SRS antenna selection for the set of SRS resources.

The UE 502 and the base station 504 may be configured to communicate (e.g., transmit/provide, receive, and/or exchange one or more communications 512) in accordance with the best set of antennas connected to the first number of Tx chains (e.g., 602 in FIG. 6; 702, 706 in FIG. 7; 804 in FIG. 8), e.g., subsequent to the selection (e.g., at 511; at 916/920 in FIG. 9).

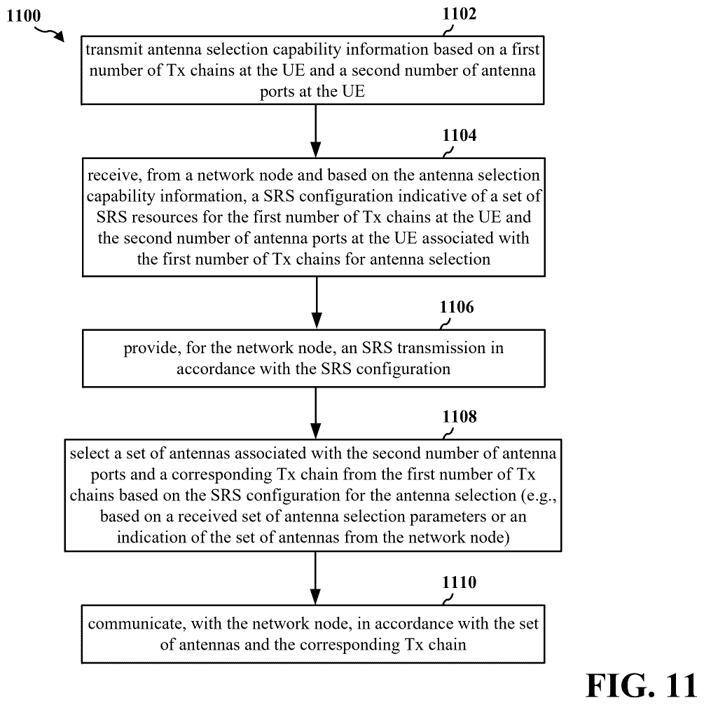

FIG. 11 is a flowchart 1100 of a method of wireless communication. The method may be performed by a UE (e.g., the UE 104, 502, 910; the apparatus 1404). The method may be for UE capability and SRS configuration for closed-loop antenna selection. The method may provide for enabling a UE and a network to cooperatively choose the best set of antennas based on SRS, such as via UE capability reporting, SRS configuration for AS, and AS operations, and thus provide closed-loop UL AS support.

At 1102, the UE transmits antenna selection capability information based on a first number of Tx chains at the UE and a second number of antenna ports at the UE. As an example, the transmission may be performed by one or more of the component 198, the transceiver(s) 1422, and/or the antennas 1480 in FIG. 14. FIG. 5 illustrates, in the context of FIGS. 6-9, an example of the UE 502 transmitting/providing such antenna selection capability information to/for a network node (e.g., the base station 504).

The UE 502 may be configured to provide/transmit, and the base station 504 may be configured to receive, antenna selection capability information 506. In aspects, the antenna selection capability information 506 may be based on a first number of Tx chains (e.g., 602 in FIG. 6; 702, 706 in FIG. 7; 804 in FIG. 8) at the UE 502 and a second number of antenna ports (e.g., 604 in FIG. 6; 704, 708 in FIG. 7; 806 in FIG. 8) at the UE 502. In aspects, the UE 502 may be configured to transmit/provide the antenna selection capability information 506, for the base station 504, as including assistance information (e.g., 917 in FIG. 9) associated with a set of UE-generated antenna selection parameters (e.g., 918 in FIG. 9). In aspects, the antenna selection capability information 506 may be indicative of at least one of per-component carrier (CC) information or per-CC combination information for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502.

The antenna selection capability information 506 may be indicative of connection information. In aspects, the connection information may include at least one of the following. In one example, the connection information may include a sub-connection (e.g., 650 in FIG. 6; 750 in FIG. 7) in which each Tx chain from the first number of Tx chains (e.g., 602 in FIG. 6; 702, 706 in FIG. 7; 804 in FIG. 8) is configured to connect with disjoint antenna port sets from the second number of antenna ports (e.g., 604 in FIG. 6; 704, 708 in FIG. 7; 806 in FIG. 8). In one example, the connection information may include a partially joint connection (e.g., 660 in FIG. 6; 760, 770 in FIG. 7) in which a common set of antenna ports from the second number of antenna ports (e.g., 604 in FIG. 6; 704, 708 in FIG. 7; 806 in FIG. 8) is connected to multiple Tx chains from the first number of Tx chains (e.g., 602 in FIG. 6; 702, 706 in FIG. 7; 804 in FIG. 8). In one example, the connection information may include a full connection (e.g., 670 in FIG. 6) in which each Tx chain from the first number of Tx chains (e.g., 602 in FIG. 6; 702, 706 in FIG. 7; 804 in FIG. 8) is configured to connect with any antenna port from the second number of antenna ports (e.g., 604 in FIG. 6; 704, 708 in FIG. 7; 806 in FIG. 8).

In some aspects, each Tx chain in the first number of Tx chains (e.g., 602 in FIG. 6; 702, 706 in FIG. 7; 804 in FIG. 8) is associated with a set of antenna port indices (e.g., 720, 730, 740 in FIG. 7), where each index of the set of antenna port indices (e.g., 720, 730, 740 in FIG. 7) is indicative of a set of antenna ports to which an associated Tx chain is configured to connect. In such aspects, the UE 502 may be configured to provide/transmit the antenna selection capability information 506 as including the set of antenna port indices (e.g., 720, 730, 740 in FIG. 7). In some aspects, the connection information may include at least one reference to a connections data structure, where the connections data structure may include an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In such aspects, the UE 502 may be configured to provide/transmit the antenna selection capability information 506 as including the at least one reference to the connections data structure. In some aspects, the connection information may include combination information. In such aspects, the combination information may include a number of antenna ports (e.g., 604 in FIG. 6; 704, 708 in FIG. 7; 806 in FIG. 8) for which subsets of Tx chain combinations from the first number of Tx chains (e.g., 602 in FIG. 6; 702, 706 in FIG. 7; 804 in FIG. 8) are configured to connect. In such aspects, the UE 502 may be configured to provide/transmit the antenna selection capability information 506 as including the combination information.

In some aspects, the UE 502 may be configured to transmit the antenna selection capability information 506 as including an antenna switching gap associated with SRS transmissions. In such aspects, the antenna switching gap may be per-UE, per-Tx chain, or per-connection. That is, the antenna switching gap may be defined as being be per-UE, per-Tx chain, or per-connection, in various aspects. In such aspects, the base station 504 may be configured, such as through an AS SRS in accordance with the SRS configuration 508, to guarantee a switching gap between SRS transmission occasions (e.g., the UE 502 may not be expected to transmit subsequent AS SRS resources within the switching gap from the previous SRS transmission).

At 1104, the UE receives, from a network node and based on the antenna selection capability information, a SRS configuration indicative of a set of SRS resources for the first number of Tx chains at the UE and the second number of antenna ports at the UE associated with the first number of Tx chains for antenna selection. As an example, the reception may be performed by one or more of the component 198, the transceiver(s) 1422, and/or the antennas 1480 in FIG. 14. FIG. 5 illustrates, in the context of FIGS. 6-9, an example of the UE 502 receiving such a SRS configuration from a network node (e.g., the base station 504).

The UE 502 may be configured to receive, and the base station 504 may be configured to provide/transmit, an SRS configuration 508. In aspects, the UE 502 may be configured to receive, and the base station 504 may be configured to provide/transmit, the SRS configuration 508 based on the antenna selection capability information 506. The SRS configuration 508 may be indicative of a set of SRS resources for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502 associated with the first number of Tx chains (e.g., 602 in FIG. 6; 702, 706 in FIG. 7; 804 in FIG. 8) for antenna selection. In aspects, the SRS configuration 508 may be indicative of a set of antenna selection parameters (e.g., 918 in FIG. 9) associated with SRS antenna selection for the set of SRS resources. In aspects, the SRS configuration 508 may be indicative of the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8).

In aspects, the SRS configuration 508 may be associated with an UL beam management procedure and may be indicative of a set of SRS resources, each SRS resource with ‘p’ antenna ports may be associated with the first number of Tx chains (e.g., 602 in FIG. 6; 702, 706 in FIG. 7; 804 in FIG. 8) based on a condition for the UL beam management procedure. In aspects, the SRS configuration 508 may be associated with antenna switching SRS resource set which has q/p SRS resources each with p ports, where ‘p’ ports of each SRS resource may be associated with different ‘p’ antenna ports of the second number of antenna ports (e.g., 604 in FIG. 6; 704, 708 in FIG. 7; 806 in FIG. 8). In aspects, the SRS configuration 508 may be associated with SRS antenna selection for the set of SRS resources and may be indicative of an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In aspects, the SRS configuration 508 may be associated with SRS antenna selection for the set of SRS resources. In such aspects, the number of SRS resources in the set is determined as

$${max}_{i = 0 , … p - 1} {N}_{{c}_{i}} ,$$

where N_{c}_{ᵢ} is the number of antennas ports connected to the i^{th} chain according to the antenna selection capability information. Each SRS resource of the set of SRS resources may have a respective number of ports of which the n^{th} port may be associated with the n^{th} antenna port connected to each chain of the first number of Tx chains (e.g., 602 in FIG. 6; 702, 706 in FIG. 7; 804 in FIG. 8). In one example, each SRS resource has the respective number of ports having a maximum number of antenna port connections. In another example, the respective number of ports being associated with a cyclical sweep of the maximum number of antenna port connections. In aspects, the SRS configuration 508 may be associated with SRS antenna selection for the set of SRS resources based on a periodic mapping in a time domain. In such aspects, the periodic mapping may be an SRS resource port-to-antenna mapping (e.g., 902 in FIG. 9), and (i) the SRS configuration may be indicative of the periodic mapping or (ii) a number of ports of an SRS resource of the set of SRS resources may be associated with a cyclical sweep of a maximum number of antenna port connections for the SRS resource.

At 1106, the UE provides, for the network node, an SRS transmission in accordance with the SRS configuration. As an example, the provision may be performed by one or more of the component 198, the transceiver(s) 1422, and/or the antennas 1480 in FIG. 14. FIG. 5 illustrates, in the context of FIGS. 6-9, an example of the UE 502 providing such an SRS transmission to a network node (e.g., the base station 504).

The UE 502 may be configured to transmit/provide, and the base station 504 may be configured to receive, an AS SRS transmission 509 (e.g., 904 in FIG. 9) in accordance with the AS SRS configuration (e.g., the SRS configuration 508).

At 1108, the UE selects a set of antennas associated with the second number of antenna ports and a corresponding Tx chain from the first number of Tx chains based on the SRS configuration for the antenna selection. As an example, the selection may be performed by one or more of the component 198, the transceiver(s) 1422, and/or the antennas 1480 in FIG. 14. FIG. 5 illustrates, in the context of FIGS. 6-9, an example of the UE 502 selecting such a set of antennas.

The base station 504 may be configured to acquire/obtain SRS measurements based on a reception of the AS SRS transmission 509 (e.g., 904 in FIG. 9). In aspects, based on the SRS measurements, the base station 504 may be configured to calculate/generate AS-related parameters (e.g., antenna selection parameters (e.g., 918 in FIG. 9)) and to provide such information to the UE 502 as an indication 510 (e.g., 914, 922 in FIG. 9). Based on AS-related parameters, the UE 502 may be configured to select/identify/determine the best set of antennas to be connected to the first number of Tx chains (e.g., 602 in FIG. 6; 702, 706 in FIG. 7; 804 in FIG. 8). For example, the UE 502 may be configured to select (at 511) (e.g., 916 in FIG. 9) a set of antennas associated with the second number of antenna ports (e.g., 604 in FIG. 6; 704, 708 in FIG. 7; 806 in FIG. 8) and a corresponding Tx chain from the first number of Tx chains (e.g., 602 in FIG. 6; 702, 706 in FIG. 7; 804 in FIG. 8) based on the SRS configuration 508, and in aspects, the selection (at 511) (e.g., 916 in FIG. 9) may be based on the AS parameters. In some aspects, based on the SRS measurements, the base station 504 may be configured to select/identify/determine (e.g., 920 in FIG. 9) the best set of antennas, e.g., the set of antennas, to be connected to the first number of Tx chains (e.g., 602 in FIG. 6; 702, 706 in FIG. 7; 804 in FIG. 8), and to provide such information to the UE 502, which may be configured to receive such information, as the indication 510 (e.g., 914, 922 in FIG. 9). For example, the UE 502 may be configured to select (at 511) (e.g., 916 in FIG. 9) the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8) based on the SRS configuration 508 for the antenna selection and the indication of the set of antennas (e.g., 918 in FIG. 9) associated with the SRS antenna selection for the set of SRS resources.

At 1110, the UE communicates, with the network node, in accordance with the set of antennas and the corresponding Tx chain. As an example, the communication may be performed by one or more of the component 198, the transceiver(s) 1422, and/or the antennas 1480 in FIG. 14. FIG. 5 illustrates, in the context of FIGS. 6-9, an example of the UE 502 communicating with a network node (e.g., the base station 504).

The UE 502 and the base station 504 may be configured to communicate (e.g., transmit/provide, receive, and/or exchange one or more communications 512) in accordance with the best set of antennas connected to the first number of Tx chains (e.g., 602 in FIG. 6; 702, 706 in FIG. 7; 804 in FIG. 8), e.g., subsequent to the selection (e.g., at 511; at 916/920 in FIG. 9).

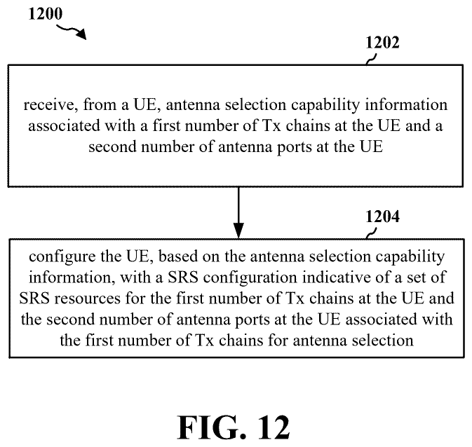

FIG. 12 is a flowchart 1200 of a method of wireless communication. The method may be performed by a base station (e.g., the base station 102, 504, 912; the network entity 1402, 1502). The method may be for UE capability and SRS configuration for closed-loop antenna selection. The method may provide for enabling a UE and a network to cooperatively choose the best set of antennas based on SRS, such as via UE capability reporting, SRS configuration for AS, and AS operations, and thus provide closed-loop UL AS support.

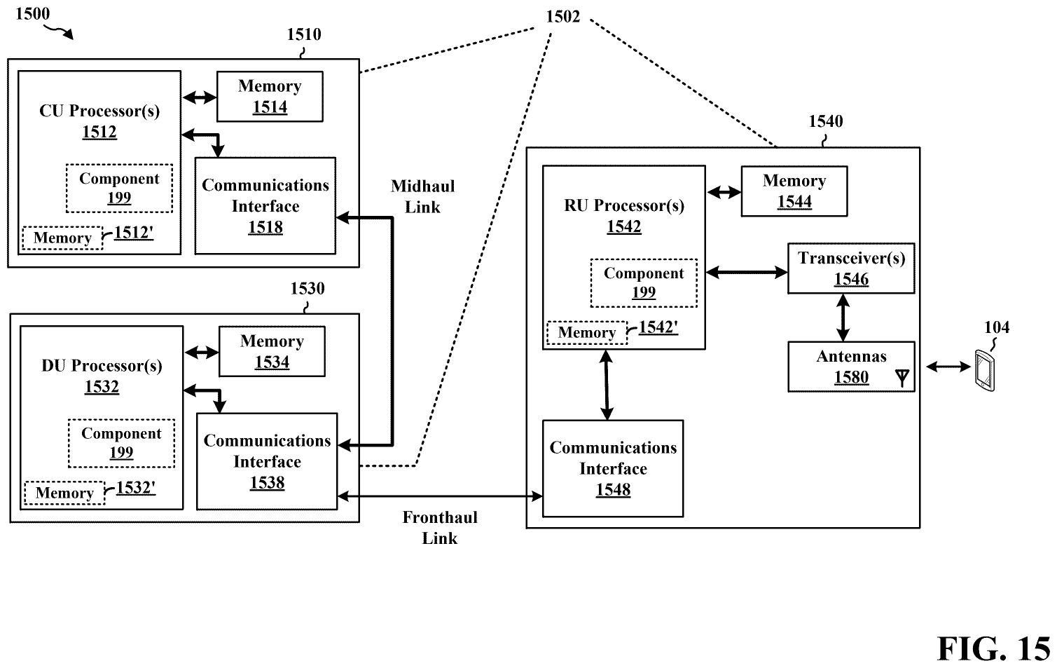

At 1202, the network node receives, from a UE, antenna selection capability information associated with a first number of Tx chains at the UE and a second number of antenna ports at the UE. As an example, the communication may be performed by one or more of the component 199, the transceiver(s) 1546, and/or the antennas 1580 in FIG. 15. FIG. 5 illustrates, in the context of FIGS. 6-9, an example of the UE 502 communicating with a network node (e.g., the base station 504).

The base station 504 may be configured to receive, and the UE 502 may be configured to provide/transmit, antenna selection capability information 506. In aspects, the antenna selection capability information 506 may be based on a first number of Tx chains (e.g., 602 in FIG. 6; 702, 706 in FIG. 7; 804 in FIG. 8) at the UE 502 and a second number of antenna ports (e.g., 604 in FIG. 6; 704, 708 in FIG. 7; 806 in FIG. 8) at the UE 502. In aspects, the UE 502 may be configured to transmit/provide the antenna selection capability information 506, for the base station 504, as including assistance information (e.g., 917 in FIG. 9) associated with a set of UE-generated antenna selection parameters (e.g., 918 in FIG. 9). In aspects, the antenna selection capability information 506 may be indicative of at least one of per-component carrier (CC) information or per-CC combination information for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502.

The antenna selection capability information 506 may be indicative of connection information. In aspects, the connection information may include at least one of the following. In one example, the connection information may include a sub-connection (e.g., 650 in FIG. 6; 750 in FIG. 7) in which each Tx chain from the first number of Tx chains (e.g., 602 in FIG. 6; 702, 706 in FIG. 7; 804 in FIG. 8) is configured to connect with disjoint antenna port sets from the second number of antenna ports (e.g., 604 in FIG. 6; 704, 708 in FIG. 7; 806 in FIG. 8). In one example, the connection information may include a partially joint connection (e.g., 660 in FIG. 6; 760, 770 in FIG. 7) in which a common set of antenna ports from the second number of antenna ports (e.g., 604 in FIG. 6; 704, 708 in FIG. 7; 806 in FIG. 8) is connected to multiple Tx chains from the first number of Tx chains (e.g., 602 in FIG. 6; 702, 706 in FIG. 7; 804 in FIG. 8). In one example, the connection information may include a full connection (e.g., 670 in FIG. 6) in which each Tx chain from the first number of Tx chains (e.g., 602 in FIG. 6; 702, 706 in FIG. 7; 804 in FIG. 8) is configured to connect with any antenna port from the second number of antenna ports (e.g., 604 in FIG. 6; 704, 708 in FIG. 7; 806 in FIG. 8).

In some aspects, each Tx chain in the first number of Tx chains (e.g., 602 in FIG. 6; 702, 706 in FIG. 7; 804 in FIG. 8) is associated with a set of antenna port indices (e.g., 720, 730, 740 in FIG. 7), where each index of the set of antenna port indices (e.g., 720, 730, 740 in FIG. 7) is indicative of a set of antenna ports to which an associated Tx chain is configured to connect. In such aspects, the UE 502 may be configured to provide/transmit the antenna selection capability information 506 as including the set of antenna port indices (e.g., 720, 730, 740 in FIG. 7). In some aspects, the connection information may include at least one reference to a connections data structure, where the connections data structure may include an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In such aspects, the UE 502 may be configured to provide/transmit the antenna selection capability information 506 as including the at least one reference to the connections data structure. In some aspects, the connection information may include combination information. In such aspects, the combination information may include a number of antenna ports (e.g., 604 in FIG. 6; 704, 708 in FIG. 7; 806 in FIG. 8) for which subsets of Tx chain combinations from the first number of Tx chains (e.g., 602 in FIG. 6; 702, 706 in FIG. 7; 804 in FIG. 8) are configured to connect. In such aspects, the UE 502 may be configured to provide/transmit the antenna selection capability information 506 as including the combination information.

In some aspects, the UE 502 may be configured to transmit the antenna selection capability information 506 as including an antenna switching gap associated with SRS transmissions. In such aspects, the antenna switching gap may be per-UE, per-Tx chain, or per-connection. That is, the antenna switching gap may be defined as being be per-UE, per-Tx chain, or per-connection, in various aspects. In such aspects, the base station 504 may be configured, such as through an AS SRS in accordance with the SRS configuration 508, to guarantee a switching gap between SRS transmission occasions (e.g., the UE 502 may not be expected to transmit subsequent AS SRS resources within the switching gap from the previous SRS transmission).

At 1204, the network node configures the UE, based on the antenna selection capability information, with a SRS configuration indicative of a set of SRS resources for the first number of Tx chains at the UE and the second number of antenna ports at the UE associated with the first number of Tx chains for antenna selection. As an example, the configuration may be performed by one or more of the component 199, the transceiver(s) 1546, and/or the antennas 1580 in FIG. 15. FIG. 5 illustrates, in the context of FIGS. 6-9, an example of the base station 504 so configuring a UE (e.g., the UE 502).

The base station 504 may be configured to provide/transmit, and the UE 502 may be configured to receive, an SRS configuration 508. In aspects, the base station 504 may be configured to provide/transmit, and the UE 502 may be configured to receive, the SRS configuration 508 based on the antenna selection capability information 506. The SRS configuration 508 may be indicative of a set of SRS resources for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502 associated with the first number of Tx chains (e.g., 602 in FIG. 6; 702, 706 in FIG. 7; 804 in FIG. 8) for antenna selection. In aspects, the SRS configuration 508 may be indicative of a set of antenna selection parameters (e.g., 918 in FIG. 9) associated with SRS antenna selection for the set of SRS resources. In aspects, the SRS configuration 508 may be indicative of the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8).

In aspects, the SRS configuration 508 may be associated with an UL beam management procedure and may be indicative of a set of SRS resources, each SRS resource with ‘p’ antenna ports may be associated with the first number of Tx chains (e.g., 602 in FIG. 6; 702, 706 in FIG. 7; 804 in FIG. 8) based on a condition for the UL beam management procedure. In aspects, the SRS configuration 508 may be associated with antenna switching SRS resource set which has q/p SRS resources each with p ports, where ‘p’ ports of each SRS resource may be associated with different ‘p’ antenna ports of the second number of antenna ports (e.g., 604 in FIG. 6; 704, 708 in FIG. 7; 806 in FIG. 8). In aspects, the SRS configuration 508 may be associated with SRS antenna selection for the set of SRS resources and may be indicative of an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In aspects, the SRS configuration 508 may be associated with SRS antenna selection for the set of SRS resources. In such aspects, the number of SRS resources in the set is determined as

$${max}_{i = 0 , … p - 1} {N}_{{c}_{i}} ,$$

where N_{c}_{ᵢ} is the number of antennas ports connected to the i^{th} chain according to the antenna selection capability information. Each SRS resource of the set of SRS resources may have a respective number of ports of which the n^{th} port may be associated with the n^{th} antenna port connected to each chain of the first number of Tx chains (e.g., 602 in FIG. 6; 702, 706 in FIG. 7; 804 in FIG. 8). In one example, each SRS resource has the respective number of ports having a maximum number of antenna port connections. In another example, the respective number of ports being associated with a cyclical sweep of the maximum number of antenna port connections. In aspects, the SRS configuration 508 may be associated with SRS antenna selection for the set of SRS resources based on a periodic mapping in a time domain. In such aspects, the periodic mapping may be an SRS resource port-to-antenna mapping (e.g., 902 in FIG. 9), and (i) the SRS configuration may be indicative of the periodic mapping or (ii) a number of ports of an SRS resource of the set of SRS resources may be associated with a cyclical sweep of a maximum number of antenna port connections for the SRS resource.

The base station 504 may be configured to receive, and the UE 502 may be configured to transmit/provide, an AS SRS transmission 509 (e.g., 904 in FIG. 9) in accordance with the AS SRS configuration (e.g., the SRS configuration 508).

The base station 504 may be configured to acquire/obtain SRS measurements based on a reception of the AS SRS transmission 509 (e.g., 904 in FIG. 9). In aspects, based on the SRS measurements, the base station 504 may be configured to calculate/generate AS-related parameters (e.g., antenna selection parameters (e.g., 918 in FIG. 9)) and to provide such information to the UE 502 as an indication 510 (e.g., 914, 922 in FIG. 9). Based on AS-related parameters, the UE 502 may be configured to select/identify/determine the best set of antennas to be connected to the first number of Tx chains (e.g., 602 in FIG. 6; 702, 706 in FIG. 7; 804 in FIG. 8). For example, the UE 502 may be configured to select (at 511) (e.g., 916 in FIG. 9) a set of antennas associated with the second number of antenna ports (e.g., 604 in FIG. 6; 704, 708 in FIG. 7; 806 in FIG. 8) and a corresponding Tx chain from the first number of Tx chains (e.g., 602 in FIG. 6; 702, 706 in FIG. 7; 804 in FIG. 8) based on the SRS configuration 508, and in aspects, the selection (at 511) (e.g., 916 in FIG. 9) may be based on the AS parameters. In some aspects, based on the SRS measurements, the base station 504 may be configured to select/identify/determine (e.g., 920 in FIG. 9) the best set of antennas, e.g., the set of antennas, to be connected to the first number of Tx chains (e.g., 602 in FIG. 6; 702, 706 in FIG. 7; 804 in FIG. 8), and to provide such information to the UE 502, which may be configured to receive such information, as the indication 510 (e.g., 914, 922 in FIG. 9). For example, the UE 502 may be configured to select (at 511) (e.g., 916 in FIG. 9) the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8) based on the SRS configuration 508 for the antenna selection and the indication of the set of antennas (e.g., 918 in FIG. 9) associated with the SRS antenna selection for the set of SRS resources.

The UE 502 and the base station 504 may be configured to communicate (e.g., transmit/provide, receive, and/or exchange one or more communications 512) in accordance with the best set of antennas connected to the first number of Tx chains (e.g., 602 in FIG. 6; 702, 706 in FIG. 7; 804 in FIG. 8), e.g., subsequent to the selection (e.g., at 511; at 916/920 in FIG. 9).

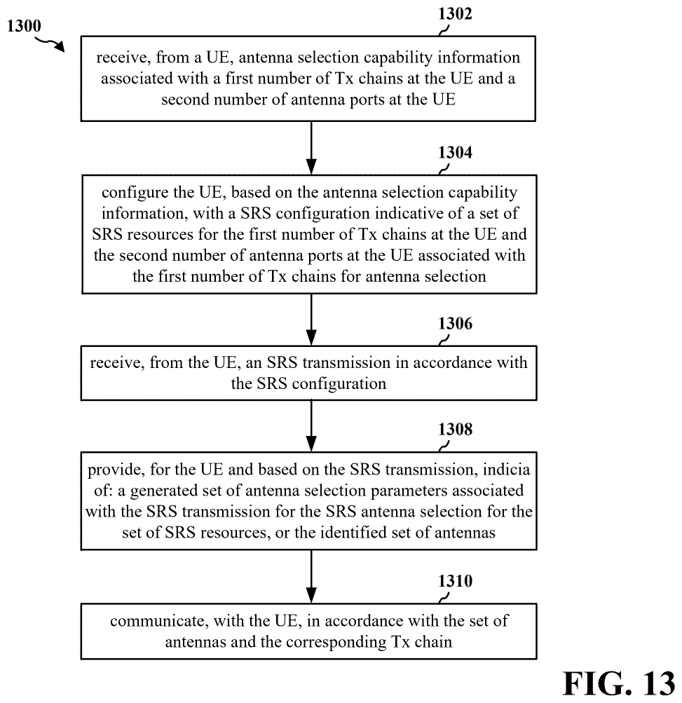

FIG. 13 is a flowchart 1300 of a method of wireless communication. The method may be performed by a base station (e.g., the base station 102, 504, 912; the network entity 1402, 1502). The method may be for UE capability and SRS configuration for closed-loop antenna selection. The method may provide for enabling a UE and a network to cooperatively choose the best set of antennas based on SRS, such as via UE capability reporting, SRS configuration for AS, and AS operations, and thus provide closed-loop UL AS support.

At 1302, the network node receives, from a UE, antenna selection capability information associated with a first number of Tx chains at the UE and a second number of antenna ports at the UE. As an example, the communication may be performed by one or more of the component 199, the transceiver(s) 1546, and/or the antennas 1580 in FIG. 15. FIG. 5 illustrates, in the context of FIGS. 6-9, an example of the UE 502 communicating with a network node (e.g., the base station 504).

The base station 504 may be configured to receive, and the UE 502 may be configured to provide/transmit, antenna selection capability information 506. In aspects, the antenna selection capability information 506 may be based on a first number of Tx chains (e.g., 602 in FIG. 6; 702, 706 in FIG. 7; 804 in FIG. 8) at the UE 502 and a second number of antenna ports (e.g., 604 in FIG. 6; 704, 708 in FIG. 7; 806 in FIG. 8) at the UE 502. In aspects, the UE 502 may be configured to transmit/provide the antenna selection capability information 506, for the base station 504, as including assistance information (e.g., 917 in FIG. 9) associated with a set of UE-generated antenna selection parameters (e.g., 918 in FIG. 9). In aspects, the antenna selection capability information 506 may be indicative of at least one of per-component carrier (CC) information or per-CC combination information for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502.

The antenna selection capability information 506 may be indicative of connection information. In aspects, the connection information may include at least one of the following. In one example, the connection information may include a sub-connection (e.g., 650 in FIG. 6; 750 in FIG. 7) in which each Tx chain from the first number of Tx chains (e.g., 602 in FIG. 6; 702, 706 in FIG. 7; 804 in FIG. 8) is configured to connect with disjoint antenna port sets from the second number of antenna ports (e.g., 604 in FIG. 6; 704, 708 in FIG. 7; 806 in FIG. 8). In one example, the connection information may include a partially joint connection (e.g., 660 in FIG. 6; 760, 770 in FIG. 7) in which a common set of antenna ports from the second number of antenna ports (e.g., 604 in FIG. 6; 704, 708 in FIG. 7; 806 in FIG. 8) is connected to multiple Tx chains from the first number of Tx chains (e.g., 602 in FIG. 6; 702, 706 in FIG. 7; 804 in FIG. 8). In one example, the connection information may include a full connection (e.g., 670 in FIG. 6) in which each Tx chain from the first number of Tx chains (e.g., 602 in FIG. 6; 702, 706 in FIG. 7; 804 in FIG. 8) is configured to connect with any antenna port from the second number of antenna ports (e.g., 604 in FIG. 6; 704, 708 in FIG. 7; 806 in FIG. 8).

In some aspects, each Tx chain in the first number of Tx chains (e.g., 602 in FIG. 6; 702, 706 in FIG. 7; 804 in FIG. 8) is associated with a set of antenna port indices (e.g., 720, 730, 740 in FIG. 7), where each index of the set of antenna port indices (e.g., 720, 730, 740 in FIG. 7) is indicative of a set of antenna ports to which an associated Tx chain is configured to connect. In such aspects, the UE 502 may be configured to provide/transmit the antenna selection capability information 506 as including the set of antenna port indices (e.g., 720, 730, 740 in FIG. 7). In some aspects, the connection information may include at least one reference to a connections data structure, where the connections data structure may include an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In such aspects, the UE 502 may be configured to provide/transmit the antenna selection capability information 506 as including the at least one reference to the connections data structure. In some aspects, the connection information may include combination information. In such aspects, the combination information may include a number of antenna ports (e.g., 604 in FIG. 6; 704, 708 in FIG. 7; 806 in FIG. 8) for which subsets of Tx chain combinations from the first number of Tx chains (e.g., 602 in FIG. 6; 702, 706 in FIG. 7; 804 in FIG. 8) are configured to connect. In such aspects, the UE 502 may be configured to provide/transmit the antenna selection capability information 506 as including the combination information.

In some aspects, the UE 502 may be configured to transmit the antenna selection capability information 506 as including an antenna switching gap associated with SRS transmissions. In such aspects, the antenna switching gap may be per-UE, per-Tx chain, or per-connection. That is, the antenna switching gap may be defined as being be per-UE, per-Tx chain, or per-connection, in various aspects. In such aspects, the base station 504 may be configured, such as through an AS SRS in accordance with the SRS configuration 508, to guarantee a switching gap between SRS transmission occasions (e.g., the UE 502 may not be expected to transmit subsequent AS SRS resources within the switching gap from the previous SRS transmission).

At 1304, the network node configures the UE, based on the antenna selection capability information, with a SRS configuration indicative of a set of SRS resources for the first number of Tx chains at the UE and the second number of antenna ports at the UE associated with the first number of Tx chains for antenna selection. As an example, the configuration may be performed by one or more of the component 199, the transceiver(s) 1546, and/or the antennas 1580 in FIG. 15. FIG. 5 illustrates, in the context of FIGS. 6-9, an example of the base station 504 so configuring a UE (e.g., the UE 502).

The base station 504 may be configured to provide/transmit, and the UE 502 may be configured to receive, an SRS configuration 508. In aspects, the base station 504 may be configured to provide/transmit, and the UE 502 may be configured to receive, the SRS configuration 508 based on the antenna selection capability information 506. The SRS configuration 508 may be indicative of a set of SRS resources for the first number of Tx chains (e.g., 602 in FIG. 6; 702, 706 in FIG. 7; 804 in FIG. 8) at the UE 502 and the second number of antenna ports (e.g., 604 in FIG. 6; 704, 708 in FIG. 7; 806 in FIG. 8) at the UE 502 associated with the first number of Tx chains (e.g., 602 in FIG. 6; 702, 706 in FIG. 7; 804 in FIG. 8) for antenna selection. In aspects, the SRS configuration 508 may be indicative of a set of antenna selection parameters (e.g., 918 in FIG. 9) associated with SRS antenna selection for the set of SRS resources. In aspects, the SRS configuration 508 may be indicative of the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8).

In aspects, the SRS configuration 508 may be associated with an UL beam management procedure and may be indicative of a set of SRS resources, each SRS resource with ‘p’ antenna ports may be associated with the first number of Tx chains (e.g., 602 in FIG. 6; 702, 706 in FIG. 7; 804 in FIG. 8) based on a condition for the UL beam management procedure. In aspects, the SRS configuration 508 may be associated with antenna switching SRS resource set which has q/p SRS resources each with p ports, where ‘p’ ports of each SRS resource may be associated with different ‘p’ antenna ports of the second number of antenna ports (e.g., 604 in FIG. 6; 704, 708 in FIG. 7; 806 in FIG. 8). In aspects, the SRS configuration 508 may be associated with SRS antenna selection for the set of SRS resources and may be indicative of an association between sets of antenna port indices (e.g., 720, 730, 740 in FIG. 7) and each Tx chain in the first number of Tx chains (e.g., 602 in FIG. 6; 702, 706 in FIG. 7; 804 in FIG. 8). In aspects, the SRS configuration 508 may be associated with SRS antenna selection for the set of SRS resources. In such aspects, the number of SRS resources in the set is determined as

$${max}_{i = 0 , … p - 1} {N}_{{c}_{i}} ,$$

where N_{c}_{ᵢ} is the number of antennas ports connected to the i^{th} chain according to the antenna selection capability information. Each SRS resource of the set of SRS resources may have a respective number of ports of which the n^{th} port may be associated with the n^{th} antenna port connected to each chain of the first number of Tx chains (e.g., 602 in FIG. 6; 702, 706 in FIG. 7; 804 in FIG. 8). In one example, each SRS resource has the respective number of ports having a maximum number of antenna port connections. In another example, the respective number of ports being associated with a cyclical sweep of the maximum number of antenna port connections. In aspects, the SRS configuration 508 may be associated with SRS antenna selection for the set of SRS resources based on a periodic mapping in a time domain. In such aspects, the periodic mapping may be an SRS resource port-to-antenna mapping (e.g., 902 in FIG. 9), and (i) the SRS configuration may be indicative of the periodic mapping or (ii) a number of ports of an SRS resource of the set of SRS resources may be associated with a cyclical sweep of a maximum number of antenna port connections for the SRS resource.

At 1306, the network node receives, from the UE, an SRS transmission in accordance with the SRS configuration. As an example, the reception may be performed by one or more of the component 199, the transceiver(s) 1546, and/or the antennas 1580 in FIG. 15. FIG. 5 illustrates, in the context of FIGS. 6-9, an example of a network node (e.g., the base station 504) receiving such an SRS transmission from a UE (e.g., the UE 502).

The base station 504 may be configured to receive, and the UE 502 may be configured to transmit/provide, an AS SRS transmission 509 (e.g., 904 in FIG. 9) in accordance with the AS SRS configuration (e.g., the SRS configuration 508).

At 1308, the network node provides, for the UE and based on the SRS transmission, indicia of: a generated set of antenna selection parameters associated with the SRS transmission for the SRS antenna selection for the set of SRS resources, or the identified set of antennas. As an example, the provision may be performed by one or more of the component 199, the transceiver(s) 1546, and/or the antennas 1580 in FIG. 15. FIG. 5 illustrates, in the context of FIGS. 6-9, an example of a network node (e.g., the base station 504) providing selecting such indicia for a UE (e.g., the UE 502).

The base station 504 may be configured to acquire/obtain SRS measurements based on a reception of the AS SRS transmission 509 (e.g., 904 in FIG. 9). In aspects, based on the SRS measurements, the base station 504 may be configured to calculate/generate AS-related parameters (e.g., antenna selection parameters (e.g., 918 in FIG. 9)) and to provide such information to the UE 502 as an indication 510 (e.g., 914, 922 in FIG. 9). Based on AS-related parameters, the UE 502 may be configured to select/identify/determine the best set of antennas to be connected to the first number of Tx chains (e.g., 602 in FIG. 6; 702, 706 in FIG. 7; 804 in FIG. 8). For example, the UE 502 may be configured to select (at 511) (e.g., 916 in FIG. 9) a set of antennas associated with the second number of antenna ports (e.g., 604 in FIG. 6; 704, 708 in FIG. 7; 806 in FIG. 8) and a corresponding Tx chain from the first number of Tx chains (e.g., 602 in FIG. 6; 702, 706 in FIG. 7; 804 in FIG. 8) based on the SRS configuration 508, and in aspects, the selection (at 511) (e.g., 916 in FIG. 9) may be based on the AS parameters. In some aspects, based on the SRS measurements, the base station 504 may be configured to select/identify/determine (e.g., 920 in FIG. 9) the best set of antennas, e.g., the set of antennas, to be connected to the first number of Tx chains (e.g., 602 in FIG. 6; 702, 706 in FIG. 7; 804 in FIG. 8), and to provide such information to the UE 502, which may be configured to receive such information, as the indication 510 (e.g., 914, 922 in FIG. 9). For example, the UE 502 may be configured to select (at 511) (e.g., 916 in FIG. 9) the set of antennas associated with the second number of antenna ports (e.g., 604 in FIG. 6; 704, 708 in FIG. 7; 806 in FIG. 8) and the corresponding Tx chain from the first number of Tx chains (e.g., 602 in FIG. 6; 702, 706 in FIG. 7; 804 in FIG. 8) based on the SRS configuration 508 for the antenna selection and the indication of the set of antennas (e.g., 918 in FIG. 9) associated with the SRS antenna selection for the set of SRS resources.

At 1310, the network node communicates, with the UE, in accordance with the set of antennas and the corresponding Tx chain. As an example, the communication may be performed by one or more of the component 199, the transceiver(s) 1546, and/or the antennas 1580 in FIG. 15. FIG. 5 illustrates, in the context of FIGS. 6-9, an example of the UE 502 communicating with a network node (e.g., the base station 504).

The UE 502 and the base station 504 may be configured to communicate (e.g., transmit/provide, receive, and/or exchange one or more communications 512) in accordance with the best set of antennas connected to the first number of Tx chains (e.g., 602 in FIG. 6; 702, 706 in FIG. 7; 804 in FIG. 8), e.g., subsequent to the selection (e.g., at 511; at 916/920 in FIG. 9).

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to transmit antenna selection capability information based on a first number of Tx chains at the UE and a second number of antenna ports at the UE. The component 198 may also be configured to receive, from a network node and based on the antenna selection capability information, a SRS configuration indicative of a set of SRS resources for the first number of Tx chains at the UE and the second number of antenna ports at the UE associated with the first number of Tx chains for antenna selection. The component 198 may also be configured to provide, for the network node, an SRS transmission in accordance with the SRS configuration. The component 198 may also be configured to select a set of antennas associated with the second number of antenna ports and a corresponding Tx chain from the first number of Tx chains based on the SRS configuration for the antenna selection. The component 198 may also be configured to communicate, with the network node, in accordance with the set of antennas and the corresponding Tx chain. The component 198 may be further configured to perform any of the aspects described in connection with the flowcharts in any of FIGS. 10, 11, 12, 13, and/or any of the aspects performed by a UE for any of FIGS. 4-9. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for transmitting antenna selection capability information based on a first number of Tx chains at the UE and a second number of antenna ports at the UE. In one configuration, the apparatus 1404, and in particular the cellular baseband processor(s) 1424 and/or the application processor(s) 1406, may include means for receiving, from a network node and based on the antenna selection capability information, a SRS configuration indicative of a set of SRS resources for the first number of Tx chains at the UE and the second number of antenna ports at the UE associated with the first number of Tx chains for antenna selection. In one configuration, the apparatus 1404, and in particular the cellular baseband processor(s) 1424 and/or the application processor(s) 1406, may include means for providing, for the network node, an SRS transmission in accordance with the SRS configuration. In one configuration, the apparatus 1404, and in particular the cellular baseband processor(s) 1424 and/or the application processor(s) 1406, may include means for selecting a set of antennas associated with the second number of antenna ports and a corresponding Tx chain from the first number of Tx chains based on the SRS configuration for the antenna selection. In one configuration, the apparatus 1404, and in particular the cellular baseband processor(s) 1424 and/or the application processor(s) 1406, may include means for communicating, with the network node, in accordance with the set of antennas and the corresponding Tx chain. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, antenna selection capability information associated with a first number of Tx chains at the UE and a second number of antenna ports at the UE. The component 199 may also be configured to configure the UE, based on the antenna selection capability information, with a SRS configuration indicative of a set of SRS resources for the first number of Tx chains at the UE and the second number of antenna ports at the UE associated with the first number of Tx chains for antenna selection. The component 199 may also be configured to receive, from the UE, an SRS transmission in accordance with the SRS configuration. The component 199 may also be configured to provide, for the UE, antenna selection information indicative of a set of antennas and a corresponding Tx chain or an indication of the set of antennas based on the SRS transmission associated with the SRS configuration. The component 199 may also be configured to communicate, with the UE, in accordance with the set of antennas and the corresponding Tx chain. The component 199 may be further configured to perform any of the aspects described in connection with the flowcharts in any of FIGS. 10, 11, 12, 13, and/or any of the aspects performed by a network node for any of FIGS. 4-9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for receiving, from a UE, antenna selection capability information associated with a first number of Tx chains at the UE and a second number of antenna ports at the UE. In one configuration, the network entity 1502 may include means for configuring the UE, based on the antenna selection capability information, with a SRS configuration indicative of a set of SRS resources for the first number of Tx chains at the UE and the second number of antenna ports at the UE associated with the first number of Tx chains for antenna selection. In one configuration, the network entity 1502 may include means for receiving, from the UE, an SRS transmission in accordance with the SRS configuration. In one configuration, the network entity 1502 may include means for providing, for the UE, antenna selection information indicative of a set of antennas and a corresponding Tx chain or an indication of the set of antennas based on the SRS transmission associated with the SRS configuration. In one configuration, the network entity 1502 may include means for communicating, with the UE, in accordance with the set of antennas and the corresponding Tx chain. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

A UE in a wireless communication network may communicate in various configurations and using various communication schema with a network node utilizing Tx chains and associated antennas. In one example, such as for UL, a UE may have a smaller number of Tx chains (e.g., a maximum number of baseband layers) than the number of antennas, and such extra antennas may be already available for reception (Rx) purposes (e.g., there may typically be more Rx chains that are employed than Tx chains). If a UE is capable of switching connections from chains to antennas, it may be beneficial to select the best set of antennas via AS to be connected to the chains, depending on per-antenna Tx power budget, the overall propagation channel from UE baseband to gNB baseband, etc., where a power amplifier for Tx may could be per-chain or per-antenna. For CB-based uplink MIMO scenarios, a UE may be configured with up to two SRS resources per set based on current solutions. Each resource in a given set may have the same number of SRS ports. In UL grants, an SRI selects one of the two resources, and a TPMI provides precoding information on the selected p-port SRS resources. If CB-based uplink MIMO for p chains and q antennas is reused for AS, two SRS resources (e.g., each with p-ports) may be configured, each resource may correspond to different connection cases which may be transparent to the network (e.g., a base station, gNB, etc.), and the network may select one from the two connections (e.g., each corresponds to each SRS resource) and indicate it using the SRI. For NCB-based uplink MIMO, a UE may be configured with up to 4 (or 8) SRS resources per set, and each resource may have a single port. In UL grants, the SRI may select ‘k’ (e.g., where k<min(Lₘₐₓ, N_{SRS})) of the configured SRS resources, and TPMI may not transmitted. Again, if NCB-based uplink MIMO for p chains and q antennas is reused for antenna selection, ‘q’ SRS resources (e.g., each corresponding to each antenna) may be configured, Lₘₐₓ may be set as ‘p’, and the network may choose up to ‘p’ of the ‘q’ resources. In 5G NR, UL AS may be determined by a UE in an open-loop manner (e.g., as transparent to the network). In some solutions, the best set of antennas may be determined based on DL measurements and per-antenna power budget, such as when some level of UL/DL reciprocity may be assumed/determined. However, the CB-based UL MIMO approach noted above cannot support sufficient flexibility to support different connection cases from chains to antennas, and simple extensions increasing the number of resources leads to significant increases to SRS resource overhead. Similarly, the NCB-based UL MIMO approach noted above has drawbacks, as such an approach may be applicable to non-coherent and fully connected AS architectures but not to other AS architectures. Additionally, there are drawbacks for such open-loop UL AS solutions, as described above, due to mismatches between UL and DL on insertion loss, antenna correlation for frequency division duplexed FDD/TDD, and propagation channel-related parameters, e.g., especially in FDD. When a UE has a larger number of chains and antennas (e.g., as seen in some trends for UE improvement), the impact of such mismatches may be further increased.

Aspects herein for UE capability and SRS configuration for closed-loop antenna selection provide solutions to such issues. For example, a UE may be configured to provide, e.g., to a base station, gNB, etc., capability reporting associated with antenna selection architecture(s) of the UE (e.g., pCqA, where there are ‘p’ Tx chains and ‘q’ antenna ports, and where p>q; pCqA may include a number ‘p’ of Tx chains, where (p): (1), 2, 3, 4, and may include a number ‘q’ of antenna ports, where (q): (2), 3, 4, 6, 8. In some examples, a UE may be configured to provide connection capability(ies) between Tx chains and antenna ports and/or indications for consideration of carrier aggregation. In some examples, SRS configuration for AS may be utilized, e.g., based on the capability reporting. For instance, SRS-based uplink beam management procedures may be reused, antenna switching SRS configuration may be reused, explicit configurations with antenna indices for each SRS resource may be used, implicit rule to derive AS SRS configurations may be used, and/or time-domain implicit antenna switching based on AS may be used. In some examples, a UE may perform AS operations based network-generated parameters, e.g., calculated based on AS SRS measurements, and a network node may perform AS operations based on UE assistance information and AS SRS measurements. The described aspects provide closed-loop UL AS support by enabling a UE and the network to cooperatively choose the best set of antennas based on SRS. The described aspects also enable closed-loop antenna selection in NR with CB- or NCB-based uplink MIMO by enabling a UE and the network to cooperatively choose the best set of antennas based on SRS. Accordingly, aspects herein enable a UE and the network to cooperatively choose the best set of antennas based on SRS, such as via UE capability reporting, SRS configuration for AS, and AS operations, and thus provide closed-loop UL AS support.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1. A method of wireless communication at a user equipment (UE), comprising: transmitting, for a network node, antenna selection capability information based on a first number of transmission (Tx) chains at the UE and a second number of antenna ports at the UE; and receiving, from the network node and based on the antenna selection capability information, a sounding reference signal (SRS) configuration indicative of a set of SRS resources for the first number of Tx chains at the UE and the second number of antenna ports at the UE associated with the first number of Tx chains for antenna selection.

Aspect 2. The method of aspect 1, further comprising: providing, for the network node, an SRS transmission in accordance with the SRS configuration; selecting a set of antennas associated with the second number of antenna ports and a corresponding Tx chain from the first number of Tx chains based on the SRS configuration for the antenna selection; and communicating, with the network node, in accordance with the set of antennas and the corresponding Tx chain.

Aspect 3. The method of aspect 2, wherein selecting the set of antennas associated with the second number of antenna ports and the corresponding Tx chain from the first number of Tx chains includes: receiving, from the network node, a set of antenna selection parameters associated with the SRS transmission for the SRS antenna selection for the set of SRS resources, and selecting the set of antennas further based on the set of antenna selection parameters associated with SRS antenna selection for the set of SRS resources; or wherein transmitting the antenna selection capability information includes: transmitting, for the network node, assistance information associated with a set of UE-generated antenna selection parameters, and wherein selecting the set of antennas associated with the second number of antenna ports and the corresponding Tx chain from the first number of Tx chains includes: receiving, from the network node, an indication of the set of antennas associated with the second number of antenna ports and the corresponding Tx chain from the first number of Tx chains.

Aspect 4. The method of any of aspects 1 to 3, wherein the antenna selection capability information is indicative of at least one of per-component carrier (CC) information or per-CC combination information for the first number of Tx chains at the UE and the second number of antenna ports at the UE.

Aspect 5. The method of any of aspects 1 to 4, wherein the antenna selection capability information is indicative of connection information, wherein the connection information includes at least one of: a sub-connection in which each Tx chain from the first number of Tx chains is configured to connect with disjoint antenna port sets from the second number of antenna ports; a partially joint connection in which a common set of antenna ports from the second number of antenna ports is connected to multiple Tx chains from the first number of Tx chains; or a full connection in which each Tx chain from the first number of Tx chains is configured to connect with any antenna port from the second number of antenna ports.

Aspect 6. The method of aspect 5, wherein each Tx chain in the first number of Tx chains is associated with a set of antenna port indices, wherein each index of the set of antenna port indices is indicative of a set of antenna ports to which an associated Tx chain is configured to connect; wherein transmitting the antenna selection capability information includes transmitting the set of antenna port indices.

Aspect 7. The method of aspect 5, wherein the connection information includes at least one reference to a connections data structure, wherein the connections data structure includes an association between sets of antenna port indices and each Tx chain in the first number of Tx chains; wherein transmitting the antenna selection capability information includes transmitting the at least one reference to the connections data structure.

Aspect 8. The method of aspect 5, wherein the connection information includes combination information, wherein the combination information includes a number of antenna ports for which subsets of Tx chain combinations from the first number of Tx chains are configured to connect; wherein transmitting the antenna selection capability information includes transmitting the combination information.

Aspect 9. The method of any of aspects 1 to 8, wherein the SRS configuration is associated with an uplink (UL) beam management procedure and is indicative of an SRS resource of the set of SRS resources based on a condition for the UL beam management procedure.

Aspect 10. The method of any of aspects 1 to 8, wherein the SRS configuration is associated with SRS antenna selection for the set of SRS resources, wherein the antenna selection is based on the SRS antenna selection.

Aspect 11. The method of any of aspects 1 to 8, wherein the SRS configuration is associated with SRS antenna selection for the set of SRS resources and is indicative of an association between sets of antenna port indices and each Tx chain in the first number of Tx chains.

Aspect 12. The method of any of aspects 1 to 8, wherein the SRS configuration is associated with SRS antenna selection for the set of SRS resources, wherein each SRS resource of the set of SRS resources is associated with a respective number of ports, wherein the antenna selection is based on (i) a port of the respective number of ports having a maximum number of antenna port connections or (ii) the respective number of ports being associated with a cyclical sweep of the maximum number of antenna port connections.

Aspect 13. The method of any of aspects 1 to 8, wherein the SRS configuration is associated with SRS antenna selection for the set of SRS resources, wherein the antenna selection is based on a periodic mapping in a time domain, wherein the periodic mapping is an SRS resource port-to-antenna mapping, wherein (i) the SRS configuration is indicative of the periodic mapping or (ii) a number of ports of an SRS resource of the set of SRS resources being associated with a cyclical sweep of a maximum number of antenna port connections for the SRS resource.

Aspect 14. The method of any of aspects 1 to 13, wherein transmitting the antenna selection capability information includes: transmitting, for the network node, an antenna switching gap associated with SRS transmissions, wherein the antenna switching gap is per-UE, per-Tx chain, or per-connection.

Aspect 15. A method of wireless communication at a network node, comprising: receiving, from a user equipment (UE), antenna selection capability information associated with a first number of transmission (Tx) chains at the UE and a second number of antenna ports at the UE; and configuring the UE, based on the antenna selection capability information, with a sounding reference signal (SRS) configuration indicative of a set of SRS resources for the first number of Tx chains at the UE and the second number of antenna ports at the UE associated with the first number of Tx chains for antenna selection.

Aspect 16. The method of aspect 15, further comprising: receiving, from the UE, an SRS transmission in accordance with the SRS configuration; providing, for the UE, antenna selection information indicative of a set of antennas and a corresponding Tx chain or an indication of the set of antennas based on the SRS transmission associated with the SRS configuration; and communicating, with the UE, in accordance with the set of antennas and the corresponding Tx chain.

Aspect 17. The method of aspect 16, wherein the SRS configuration is indicative of a set of antenna selection parameters associated with SRS antenna selection for the set of SRS resources, and wherein providing the antenna selection information includes generating the set of antenna selection parameters associated with SRS antenna selection for the set of SRS resources; or wherein receiving the antenna selection capability information includes receiving, from the UE, assistance information associated with a set of UE-generated antenna selection parameters, wherein the indication of the set of antennas associated with the second number of antenna ports is based on the assistance information.

Aspect 18. The method of any of aspects 15 to 17, wherein the antenna selection capability information is indicative of at least one of per-component carrier (CC) information or per-CC combination information for the first number of Tx chains at the UE and the second number of antenna ports at the UE.

Aspect 19. The method of any of aspects 15 to 18, wherein the antenna selection capability information is indicative of connection information, wherein the connection information includes at least one of: a sub-connection in which each Tx chain from the first number of Tx chains is configured to connect with disjoint antenna port sets from the second number of antenna ports; a partially joint connection in which a common set of antenna ports from the second number of antenna ports is connected to multiple Tx chains from the first number of Tx chains; or a full connection in which each Tx chain from the first number of Tx chains is configured to connect with any antenna port from the second number of antenna ports.

Aspect 20. The method of aspect 19, wherein each Tx chain in the first number of Tx chains is associated with a set of antenna port indices, wherein each index of the set of antenna port indices is indicative of a set of antenna ports to which an associated Tx chain is configured to connect; wherein receiving the antenna selection capability information includes receiving the set of antenna port indices.

Aspect 21. The method of aspect 19, wherein the connection information includes at least one reference to a connections data structure, wherein the connections data structure includes an association between sets of antenna port indices and each Tx chain in the first number of Tx chains; wherein receiving the antenna selection capability information includes receiving the at least one reference to the connections data structure.

Aspect 22. The method of aspect 19, wherein the connection information includes combination information, wherein the combination information includes a number of antenna ports for which subsets of Tx chain combinations from the first number of Tx chains are configured to connect; wherein receiving the antenna selection capability information includes receiving the combination information.

Aspect 23. The method of any of aspects 15 to 22, wherein the SRS configuration is associated with an uplink (UL) beam management procedure and is indicative of an SRS resource of the set of SRS resources based on a condition for the UL beam management procedure.

Aspect 24. The method of any of aspects 15 to 22, wherein the SRS configuration is associated with SRS antenna selection for the set of SRS resources, wherein the antenna selection is based on the SRS antenna selection.

Aspect 25. The method of any of aspects 15 to 22, wherein the SRS configuration is associated with SRS antenna selection for the set of SRS resources and is indicative of an association between sets of antenna port indices and each Tx chain in the first number of Tx chains.

Aspect 26. The method of any of aspects 15 to 22, wherein the SRS configuration is associated with SRS antenna selection for the set of SRS resources, wherein each SRS resource of the set of SRS resources is associated with a respective number of ports, wherein the antenna selection is based on (i) a port of the respective number of ports having a maximum number of antenna port connections or (ii) the respective number of ports being associated with a cyclical sweep of the maximum number of the antenna port connections.

Aspect 27. The method of any of aspects 15 to 22, wherein the SRS configuration is associated with SRS antenna selection for the set of SRS resources, wherein the antenna selection is based on a periodic mapping in a time domain, wherein the periodic mapping is an SRS resource port-to-antenna mapping, wherein (i) the SRS configuration is indicative of the periodic mapping or (ii) a number of ports of an SRS resource of the set of SRS resources being associated with a cyclical sweep of a maximum number of antenna port connections for the SRS resource.

Aspect 28. The method of any of aspects 15 to 27, wherein receiving the antenna selection capability information includes: receiving, from the UE, an antenna switching gap associated with SRS transmissions, wherein the antenna switching gap is per-UE, per-Tx chain, or per-connection.

Aspect 29. An apparatus for wireless communication at a user equipment (UE), comprising: at least one memory; and at least one processor coupled to the at least one memory, the at least one processor, individually or in any combination, is configured to perform the method of any of aspects 1 to 14.

Aspect 30. An apparatus for wireless communication at a user equipment (UE), comprising means for performing each step in the method of any of aspects 1 to 14.

Aspect 31. The apparatus of any of aspects 29 and 30, further comprising a transceiver configured to receive or to transmit in association with the method of any of aspects 1 to 14.

Aspect 32. A computer-readable medium (e.g., a non-transitory computer-readable medium) storing computer executable code at a user equipment (UE), the code when executed by at least one processor causes the at least one processor to perform the method of any of aspects 1 to 14.

Aspect 33. An apparatus for wireless communication at a network node, comprising: at least one memory; and at least one processor coupled to the at least one memory, the at least one processor, individually or in any combination, is configured to perform the method of any of aspects 15 to 28.

Aspect 34. An apparatus for wireless communication at a network node, comprising means for performing each step in the method of any of aspects 15 to 28.

Aspect 35. The apparatus of any of aspects 33 and 34, further comprising a transceiver configured to receive or to transmit in association with the method of any of aspects 15 to 28.

Aspect 36. A computer-readable medium (e.g., a non-transitory computer-readable medium) storing computer executable code at a network node, the code when executed by at least one processor causes the at least one processor to perform the method of any of aspects 15 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
transmit, for a network node, antenna selection capability information based on a first number of transmission (Tx) chains at the UE and a second number of antenna ports at the UE; and
receive, from the network node and based on the antenna selection capability information, a sounding reference signal (SRS) configuration indicative of a set of SRS resources for the first number of Tx chains at the UE and the second number of antenna ports at the UE associated with the first number of Tx chains for antenna selection.

2. The apparatus of claim 1, further comprising at least one transceiver coupled to the at least one processors;
wherein the at least one processor, individually or in any combination, is further configured to:
provide, for the network node, an SRS transmission in accordance with the SRS configuration;
select a set of antennas associated with the second number of antenna ports and a corresponding Tx chain from the first number of Tx chains based on the SRS configuration for the antenna selection; and
communicate, with the network node via the at least one transceiver, in accordance with the set of antennas and the corresponding Tx chain.

3. The apparatus of claim 2, wherein to select the set of antennas associated with the second number of antenna ports and the corresponding Tx chain from the first number of Tx chains, the at least one processor, individually or in any combination, is configured to:
receive, from the network node, a set of antenna selection parameters associated with the SRS transmission for the SRS antenna selection for the set of SRS resources, and
select the set of antennas further based on the set of antenna selection parameters associated with the SRS antenna selection for the set of SRS resources; or
wherein to transmit the antenna selection capability information, the at least one processor, individually or in any combination, is configured to:
transmit, for the network node, assistance information associated with a set of UE-generated antenna selection parameters, and
wherein to select the set of antennas associated with the second number of antenna ports and the corresponding Tx chain from the first number of Tx chains, the at least one processor, individually or in any combination, is configured to:
receive, from the network node, an indication of the set of antennas associated with the second number of antenna ports and the corresponding Tx chain from the first number of Tx chains.

4. The apparatus of claim 1, wherein the antenna selection capability information is indicative of at least one of per-component carrier (CC) information or per-CC combination information for the first number of Tx chains at the UE and the second number of antenna ports at the UE.

5. The apparatus of claim 1, wherein the antenna selection capability information is indicative of connection information, wherein the connection information includes at least one of:
a sub-connection in which each Tx chain from the first number of Tx chains is configured to connect with disjoint antenna port sets from the second number of antenna ports;
a partially joint connection in which a common set of antenna ports from the second number of antenna ports is connected to multiple Tx chains from the first number of Tx chains; or
a full connection in which each Tx chain from the first number of Tx chains is configured to connect with any antenna port from the second number of antenna ports.

6. The apparatus of claim 5, wherein each Tx chain in the first number of Tx chains is associated with a set of antenna port indices, wherein each index of the set of antenna port indices is indicative of a set of antenna ports to which an associated Tx chain is configured to connect;
wherein to transmit the antenna selection capability information, the at least one processor, individually or in any combination, is configured to transmit the set of antenna port indices.

7. The apparatus of claim 5, wherein the connection information includes at least one reference to a connections data structure, wherein the connections data structure includes an association between sets of antenna port indices and each Tx chain in the first number of Tx chains;
wherein to transmit the antenna selection capability information, the at least one processor, individually or in any combination, is configured to transmit the at least one reference to the connections data structure.

8. The apparatus of claim 5, wherein the connection information includes combination information, wherein the combination information includes a number of antenna ports for which subsets of Tx chain combinations from the first number of Tx chains are configured to connect;
wherein to transmit the antenna selection capability information, the at least one processor, individually or in any combination, is configured to transmit the combination information.

9. The apparatus of claim 1, wherein the SRS configuration is associated with an uplink (UL) beam management procedure and is indicative of an SRS resource of the set of SRS resources based on a condition for the UL beam management procedure.

10. The apparatus of claim 1, wherein the SRS configuration is associated with SRS antenna selection for the set of SRS resources, wherein the antenna selection is based on the SRS antenna selection.

11. The apparatus of claim 1, wherein the SRS configuration is associated with SRS antenna selection for the set of SRS resources and is indicative of an association between sets of antenna port indices and each Tx chain in the first number of Tx chains.

12. The apparatus of claim 1, wherein the SRS configuration is associated with SRS antenna selection for the set of SRS resources, wherein each SRS resource of the set of SRS resources is associated with a respective number of ports, wherein the antenna selection is based on (i) a port of the respective number of ports having a maximum number of antenna port connections or (ii) the respective number of ports being associated with a cyclical sweep of the maximum number of antenna port connections.

13. The apparatus of claim 1, wherein the SRS configuration is associated with SRS antenna selection for the set of SRS resources, wherein the antenna selection is based on a periodic mapping in a time domain, wherein the periodic mapping is an SRS resource port-to-antenna mapping, wherein (i) the SRS configuration is indicative of the periodic mapping or (ii) a number of ports of an SRS resource of the set of SRS resources being associated with a cyclical sweep of a maximum number of antenna port connections for the SRS resource.

14. The apparatus of claim 1, wherein to transmit the antenna selection capability information, the at least one processor, individually or in any combination, is configured to:
transmit, for the network node, an antenna switching gap associated with SRS transmissions, wherein the antenna switching gap is per-UE, per-Tx chain, or per-connection.

15. An apparatus for wireless communication at a network node, comprising:
at least one memory; and
at least one processor coupled to the at least one memory and, based at least in part on information stored in the at least one memory, the at least one processor, individually or in any combination, is configured to:
receive, from a user equipment (UE), antenna selection capability information associated with a first number of transmission (Tx) chains at the UE and a second number of antenna ports at the UE; and
configure the UE, based on the antenna selection capability information, with a sounding reference signal (SRS) configuration indicative of a set of SRS resources for the first number of Tx chains at the UE and the second number of antenna ports at the UE associated with the first number of Tx chains for antenna selection.

16. The apparatus of claim 15, further comprising at least one transceiver coupled to the at least one processors, wherein the at least one processor, individually or in any combination, is further configured to:
receive, from the UE, an SRS transmission in accordance with the SRS configuration;
provide, for the UE, antenna selection information indicative of a set of antennas and a corresponding Tx chain or an indication of the set of antennas based on the SRS transmission associated with the SRS configuration; and
communicate, with the UE via the at least one transceiver, in accordance with the set of antennas and the corresponding Tx chain.

17. The apparatus of claim 16, wherein the SRS configuration is indicative of a set of antenna selection parameters associated with SRS antenna selection for the set of SRS resources, and wherein to provide the antenna selection information, the at least one processor, individually or in any combination, is configured to generate, based on the SRS transmission, the set of antenna selection parameters associated with the SRS antenna selection for the set of SRS resources; or
wherein to receive the antenna selection capability information, the at least one processor, individually or in any combination, is configured to receive, from the UE, assistance information associated with a set of UE-generated antenna selection parameters, wherein the indication of the set of antennas associated with the second number of antenna ports is based on the assistance information.

18. The apparatus of claim 15, wherein the antenna selection capability information is indicative of at least one of per-component carrier (CC) information or per-CC combination information for the first number of Tx chains at the UE and the second number of antenna ports at the UE.

19. The apparatus of claim 15, wherein the antenna selection capability information is indicative of connection information, wherein the connection information includes at least one of:
a sub-connection in which each Tx chain from the first number of Tx chains is configured to connect with disjoint antenna port sets from the second number of antenna ports;
a partially joint connection in which a common set of antenna ports from the second number of antenna ports is connected to multiple Tx chains from the first number of Tx chains; or
a full connection in which each Tx chain from the first number of Tx chains is connected with any antenna port from the second number of antenna ports.

20. The apparatus of claim 19, wherein each Tx chain in the first number of Tx chains is associated with a set of antenna port indices, wherein each index of the set of antenna port indices is indicative of a set of antenna ports to which an associated Tx chain is configured to connect;
wherein to receive the antenna selection capability information, the at least one processor, individually or in any combination, is configured to receive the set of antenna port indices.

21. The apparatus of claim 19, wherein the connection information includes at least one reference to a connections data structure, wherein the connections data structure includes an association between sets of antenna port indices and each Tx chain in the first number of Tx chains;
wherein to receive the antenna selection capability information, the at least one processor, individually or in any combination, is configured to receive the at least one reference to the connections data structure.

22. The apparatus of claim 19, wherein the connection information includes combination information, wherein the combination information includes a number of antenna ports for which subsets of Tx chain combinations from the first number of Tx chains are configured to connect;
wherein to receive the antenna selection capability information, the at least one processor, individually or in any combination, is configured to receive the combination information.

23. The apparatus of claim 15, wherein the SRS configuration is associated with an uplink (UL) beam management procedure and is indicative of an SRS resource of the set of SRS resources based on a condition for the UL beam management procedure.

24. The apparatus of claim 15, wherein the SRS configuration is associated with SRS antenna selection for the set of SRS resources, wherein the antenna selection is based on the SRS antenna selection.

25. The apparatus of claim 15, wherein the SRS configuration is associated with SRS antenna selection for the set of SRS resources and is indicative of an association between sets of antenna port indices and each Tx chain in the first number of Tx chains.

26. The apparatus of claim 15, wherein the SRS configuration is associated with SRS antenna selection for the set of SRS resources, wherein each SRS resource of the set of SRS resources is associated with a respective number of ports, wherein the antenna selection is based on (i) a port of the respective number of ports having a maximum number of antenna port connections or (ii) the respective number of ports being associated with a cyclical sweep of the maximum number of the antenna port connections.

27. The apparatus of claim 15, wherein the SRS configuration is associated with SRS antenna selection for the set of SRS resources, wherein the antenna selection is based on a periodic mapping in a time domain, wherein the periodic mapping is an SRS resource port-to-antenna mapping, wherein (i) the SRS configuration is indicative of the periodic mapping or (ii) a number of ports of an SRS resource of the set of SRS resources being associated with a cyclical sweep of a maximum number of antenna port connections for the SRS resource.

28. The apparatus of claim 15, wherein to receive the antenna selection capability information, the at least one processor, individually or in any combination, is configured to:
receive, from the UE, an antenna switching gap associated with SRS transmissions, wherein the antenna switching gap is per-UE, per-Tx chain, or per-connection.

29. A method of wireless communication at a user equipment (UE), comprising:
transmitting, for a network node, antenna selection capability information based on a first number of transmission (Tx) chains at the UE and a second number of antenna ports at the UE; and
receiving, from the network node and based on the antenna selection capability information, a sounding reference signal (SRS) configuration indicative of a set of SRS resources for the first number of Tx chains at the UE and the second number of antenna ports at the UE associated with the first number of Tx chains for antenna selection.

30. A method of wireless communication at a network node, comprising:
receiving, from a user equipment (UE), antenna selection capability information associated with a first number of transmission (Tx) chains at the UE and a second number of antenna ports at the UE; and
configuring the UE, based on the antenna selection capability information, with a sounding reference signal (SRS) configuration indicative of a set of SRS resources for the first number of Tx chains at the UE and the second number of antenna ports at the UE associated with the first number of Tx chains for antenna selection.
